(19) United States
(12) Patent Application Publication
(10) Pub. No.: US 2011/0157774 A1
(43) Pub. Date: Jun. 30, 2011

(54) Package for an Electrical Device

(76) Inventors: Phillip Brett Aitchison, New South Wales (AU); Alexander Bilyk, New South Wales (AU); Allen David Perry, New South Wales (AU); Andrzej Kucharzewski, New South Wales (AU)

(21) Appl. No.: 13/062,801

(22) PCT Filed: Sep. 9, 2009
(86) PCT No.: PCT/AU2009/001180

§ 371 Date: Mar. 8, 2011

(30) Foreign Application Priority Data
Sep. 9, 2008 (AU) 2008904698

(51) Int. Cl. H01G 9/155; H01G 9/145

(52) U.S. Cl. 361/502; 361/517

(57) ABSTRACT

A supercapacitor (1) includes two like stacked supercapacitive cells (2, 3) that are connected to each other in series. A two-piece generally prismatic sealed package (4) defines an interior (5) to contain cells (2, 3). Package (4) includes a substantially planar access sidewall (6) having two spaced apart apertures (7, 8) extending from interior (5) to an exterior of the package. Sidewall (6) contains a liquid crystal polymer (LCP). A lead assembly, in the form of two spaced apart metal leads (9, 10) are electrically connected to cells (2, 3) respectively, and extend through respective apertures (7, 8) to allow external electrical connection to the cells.

### FIELD OF THE INVENTION

The present invention relates to a package and in particular to a package for an electrical device.

The invention has been primarily developed for a supercapacitive device and will be described hereinafter with reference to that application. However, it will be appreciated that the invention is not limited to this particular field of use and, for example, may be used for other electrical devices including energy storage devices such as batteries and capacitors, and other electrical devices such as MEMS electronic devices, MEMS electromechanical devices, MEMS electrochemical devices, integrated circuit devices (IC's), and hybrids of any of the preceding electrical devices, amongst others.

### BACKGROUND OF THE INVENTION

Any discussion of the prior art throughout the specification should in no way be considered as an admission that such prior art is widely known or forms part of the common general knowledge in the field.

It is known to use liquid crystal polymer (LCP) packaging in a range of electrical/electronics components for lighting, telecommunications, auto ignition and fuel handling, aerospace, fiber optics, motors, imaging devices, sensors, ovenware, fuel or gas barrier structures, amongst others. More recently, there has been reference made to the possible use of LCP packaging for supercapacitors: for example, in US patent application 2007/0081298.

The known LCP packaging is suitable in a general sense to be formed to contain a supercapactive element. However, the known packaging is susceptible to compromising the reliable performance and operational lifetime of the supercapacitive element due to a lack of practical robustness and security during manufacture and/or subsequent use. One aspect of this susceptibility often arises from the mounting of leads to the packaging, where those leads extend from within the package allowing external electrical connection to the supercapacitive element.

### SUMMARY OF THE INVENTION

It is an object of the present invention to overcome or ameliorate at least one of the disadvantages of the prior art, or to provide a useful alternative.

According to a first aspect of the invention there is provided a package for an energy storage device having an energy storage element and at least two leads for allowing electrical connection to the element, the package including:

a plurality of sidewalls for defining an interior to contain the energy storage element and a liquid electrolyte, wherein at least one of the sidewalls is formed from liquid crystal polymer (LCP);

a mounting formation defined by one or more of the sidewalls for locating the leads to extend from the interior to an exterior of the package, wherein the package has one or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

In an embodiment, the package has two or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

In an embodiment, the package has the transmission rates of:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

In an embodiment, the package has one or more of the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cmkm²/s for the electrolyte.

In an embodiment, the package has two or more of the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

In an embodiment, the package has the following transmission rates of:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

According to a second aspect of the invention there is provided a package for an energy storage device having an energy storage element and at least two leads for allowing electrical connection to the element, the package including:

a plurality of sidewalls for defining an interior to contain the energy storage element and a liquid electrolyte;

a formation defined by one or more of the sidewalls for locating the leads to extend from the interior to an exterior of the package, wherein the package is substantially rigid and has one or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

In an embodiment, the package has two or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

In an embodiment, the package has the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

In an embodiment, the package has one or more of the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

In an embodiment, the package has two or more of the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

In an embodiment, the package has the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

According to a third aspect of the invention there is provided a package for an energy storage device having an energy storage element and at least two leads for allowing electrical connection to the element, the package including:

a plurality of sidewalls for defining both an interior to contain the energy storage element and a liquid electrolyte and a mounting face having a footprint of a predetermined area, wherein the package has a low aspect ratio;

a formation defined by one or more of the sidewalls for orientating the leads to extend from the interior to an exterior of the package, wherein the package has one or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

According to a fourth aspect of the invention there is provided a package for an energy storage device having an energy storage element and at least two leads for allowing electrical connection to the element, the package including:

a plurality of sidewalls for defining an interior to contain the energy storage element and a liquid electrolyte, wherein at least one of the sidewalls is formed from liquid crystal polymer (LCP);

a mounting formation defined by one or more of the sidewalls for locating the leads to extend from the interior to an exterior of the package, wherein the package has at least one of the following transmission rates:

less than 1×10⁻⁹ cm³.cm/cm²/s/Pa for water vapour;

less than 1×10⁻⁹ cm³.cm/cm²/s/Pa for oxygen gas; and

less than 1×10⁻⁹ cm³.cm/cm²/s for the electrolyte.

According the fifth aspect of the invention there is provided a package for an energy storage device having an energy storage element and at least two leads for allowing electrical connection to the element, the package including:

a plurality of sidewalls for defining an interior to contain the energy storage element and a liquid electrolyte;

a formation defined by one or more of the sidewalls for locating the leads to extend from the interior to an exterior of the package, wherein the package is substantially rigid and has at least one of the following transmission rates:

less than 1×10⁻⁹ cm³.cm/cm²/s/Pa for water vapour;

less than 1×10⁻⁹ cm³.cm/cm²/s/Pa for oxygen gas; and

less than 1×10⁻⁹ cm³.cm/cm²/s for the electrolyte.

In an embodiment, at least some of the sidewalls form an open-ended hollow central portion and a pair of end portion sidewalls sealingly bonded to the central portion substantially covering the open ends.

According to a sixth aspect of the invention there is provided a package for an energy storage device having an energy storage element, the package including:

a first sidewall and a second sidewall that are bonded to each other to define a sealed interior to contain the energy storage element, wherein the sidewalls each contain a liquid crystal polymer; and

a lead assembly being electrically connected to the energy storage element to allow external electrical connection to the element.

According to a seventh aspect of the invention there, is provided a method for manufacturing a package for an energy storage device having an energy storage element and at least two leads for allowing electrical connection to the element, the method including:

defining, from a plurality of sidewalls, an interior to contain the energy storage element, wherein at least one of the sidewalls is formed from liquid crystal polymer (LCP);

providing a mounting formation defined by one or more of the sidewalls for locating the leads to extend from the interior to an exterior of the package, wherein the package has one or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm2/s for a liquid electrolyte.

According to an eighth aspect of the invention there is provided a package for an electrical device having an electrical element and at least two leads for allowing electrical connection to the element, the package including:

a plurality of sidewalls for defining an interior to contain the electrical element, wherein at least one of the sidewalls is formed from liquid crystal polymer (LCP);

a mounting formation defined by one or more of the sidewalls for locating the leads to extend from the interior to an exterior of the package, wherein the package has one or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for a liquid electrolyte.

In an embodiment, the package has two or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

In an embodiment, the package has the transmission rates of:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

In an embodiment, the package has one or more of the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

In an embodiment, the package has two or more of the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

In an embodiment, the package has the following transmission rates of:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

According to a ninth aspect of the invention there is provided a package for an electrical device having an electrical element and at least two leads for allowing electrical connection to the element, the package including:

a plurality of sidewalls for defining an interior to contain the electrical element;

a formation defined by one or more of the sidewalls for locating the leads to extend from the interior to an exterior of the package, wherein the package is substantially rigid and has one or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for a liquid electrolyte.

In an embodiment, the package has two or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

In an embodiment, the package has the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

In an embodiment, the package has one or more of the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

In an embodiment, the has two or more of the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

In an embodiment, the package has the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

According to a tenth aspect of the invention there is provided a package for an electrical device having an electrical element and at least two leads for allowing electrical connection to the element, the package including:

a plurality of sidewalls for defining both an interior to contain the energy storage element and a liquid electrolyte and a mounting face having a footprint of a predetermined area, wherein the package has a low aspect ratio;

a formation defined by one or more of the sidewalls for orientating the leads to extend from the interior to an exterior of the package, wherein the package has one or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for a liquid electrolyte.

According to an eleventh aspect of the invention there is provided a package for an electrical device having an electrical element and at least two leads for allowing electrical connection to the element, the package including:

a plurality of sidewalls for defining an interior to contain the energy storage element, wherein at least one of the sidewalls is formed from liquid crystal polymer (LCP);

a mounting formation defined by one or more of the sidewalls for locating the leads to extend from the interior to an exterior of the package, wherein the package has at least one of the following transmission rates:

less than 1×10⁻⁹ cm³.cm/cm²/s/Pa for water vapour;

less than 1×10⁻⁹ cm³.cm/cm²/s/Pa for oxygen gas; and

less than 1×10⁻⁹ cm³.cm/cm²/s for a liquid electrolyte.

According to a twelfth aspect of the invention there is provided a package for an electrical device having an electrical element and at least two leads for allowing electrical connection to the element, the package including:

a plurality of sidewalls for defining an interior to contain the energy storage element;

a formation defined by one or more of the sidewalls for locating the leads to extend from the interior to an exterior of the package, wherein the package is substantially rigid and has at least one of the following transmission rates:

less than 1×10⁻⁹ cm³.cm/cm²/s/Pa for water vapour;

less than 1×10⁻⁹ cm³.cm/cm²/s/Pa for oxygen gas; and

less than 1×10⁻⁹ cm³.cm/cm²/s for a liquid electrolyte.

In an embodiment, at least some of the sidewalls form an open-ended hollow portion and the device further includes a pair of end portion sidewalls for sealingly bonding to the central portion to substantially cover the open ends.

According to a thirteenth aspect of the invention there is provided a package for an electrical device having an electrical element, the package including:

a first sidewall and a second sidewall that are bonded to each other to define a sealed interior to contain the element, wherein the sidewalls each contain a liquid crystal polymer; and

a lead assembly being electrically connected to the element to allow external electrical connection to the element.

According to a fourteenth aspect of the invention there is provided a method for manufacturing a package for an electrical device having an electrical element and at least two leads for allowing electrical connection to the element, the method including:

defining, from a plurality of sidewalls, an interior to contain the element, wherein at least one of the sidewalls is formed from liquid crystal polymer (LCP);

providing a mounting formation defined by one or more of the sidewalls for locating the leads to extend from the interior to an exterior of the package, wherein the package has one or more of the following transmission rates:

less than 1×10⁻¹² cm³.cm/cm²/s/Pa for water vapour;

less than 1×10⁻¹³ cm³.cm/cm²/s/Pa for oxygen gas; and

less than 1'10⁻⁹ cm³.cm/cm²/s for a liquid electrolyte.

According to a fifteenth aspect of the invention there is provided a package for an electrical device having an electrical element and at least two leads for allowing electrical connection to the element, the package including:

a plurality of sidewalls for defining an interior to contain the electrical element, wherein at least one of the sidewalls is formed from liquid crystal polymer (LCP);

a mounting formation defined by one or more of the sidewalls for locating the leads to extend from the interior to an exterior of the package, wherein the package has one or more of the following transmission rates:
less than 1×10⁻¹² cm³.cm/cm²/s/Pa for water vapour;
less than 1×10⁻¹³ cm³.cm/cm²/s/Pa for oxygen gas; and
less than 1×10⁻⁹ cm³.cm/cm²/s for a liquid.

In an embodiment, the liquid is an electrolyte.

In an embodiment, the electrical device is an energy storage device.

In an embodiment, the energy storage device is a supercapacitor.

In an embodiment the electrical element includes at least one pair of opposed electrodes, a non-conductor separator between the electrodes, and terminals for electrically connecting the electrodes to the leads.

According to a sixteenth aspect of the invention there is provided an electrical device including packaging from any one of the first to sixth aspects or the eighth to thirteenth aspects or the fifteenth aspect.

According to a seventeenth aspect of the invention there is provided an electronic device including one or more of the electrical devices from the sixteenth aspect.

The preferred embodiments of the invention provide an hermetic, dimensionally stable package for electrical devices with electrical leads that will be subject to the high temperatures such as during manufacture—for example, during reflow surface mount technology (SMT) assembly into electrical circuits—or high compressive forces during use.

In this specification, unless the context clearly indicates otherwise, the use of the term “an embodiment” is used generically to refer to one or more embodiments rather than a single specific embodiment.

### BRIEF DESCRIPTION OF THE DRAWINGS

Preferred embodiments of the invention will now be described, by way of example only, with reference to the accompanying drawings in which:

FIG. 1 is a side view of a supercapacitor;

FIG. 2 is a top view of the supercapacitor of FIG. 1;

FIG. 3 is a sectional view taken along line 3-3 of FIG. 2;

FIG. 4 is an end view of the supercapacitor of FIG. 1 with the lead assembly removed;

FIG. 5 is an exploded perspective view of the supercapacitor package of FIG. 1;

FIG. 6 is an enlarged side view of the supercapacitor package of FIG. 1, showing an aperture;

FIG. 7 is a sectional view taken along line 7-7 of FIG. 6;

FIG. 8 is the package and lead assembly of FIG. 7 shown sealingly bonded to each other;

FIG. 9 is a sectional view, similar to FIG. 3, of another alternate embodiment of the package and the lead assembly;

FIG. 10 is an enlarged sectional view, similar to FIG. 7, of the package and the lead assembly of FIG. 9;

FIG. 11 is the package and the lead assembly of FIG. 10 shown sealingly bonded to each other;

FIG. 12 is an enlarged sectional view, similar to FIGS. 7 and 10, of an alternate embodiment of the package and the lead assembly;

FIG. 13 is the package and the lead assembly of FIG. 12 shown sealingly bonded to each other;

FIG. 14 is an enlarged sectional view, similar to FIGS. 7, 10 and 12, of another alternate embodiment of the package and the lead assembly;

FIG. 15 is the package and the lead assembly of FIG. 14 shown sealingly bonded to each other;

FIG. 16 is an enlarged sectional view, similar to FIGS. 7, 10, 12 and 14, of the package and the lead assembly of FIG. 7 with a sealant layer;

FIG. 17 is the package and the lead assembly of FIG. 16 shown sealingly bonded to each other;

FIG. 18 is a side view, similar to FIG. 1, of another embodiment of a supercapacitor;

FIG. 19 is a top view of the supercapacitor of FIG. 18;

FIG. 20 is a sectional view taken along line 20-20 of FIG. 19;

FIG. 21 is an end view of the supercapacitor of FIG. 18 with the lead assembly removed;

FIG. 22 is an exploded perspective view of the supercapacitor package of FIG. 18;

FIG. 23 is a side view, similar to FIGS. 1 and 18, of another embodiment of a supercapacitor;

FIG. 24 is a top view of the supercapacitor of FIG. 23;

FIG. 25 is a sectional view taken along line 25-25 of FIG. 24;

FIG. 26 is an end view of the supercapacitor of FIG. 23 with the lead assembly removed;

FIGS. 27a to 27f are respective enlarged sectional view of various configurations of abutment surfaces of the supercapacitor;

FIG. 28 is an enlarged sectional view, similar to FIG. 14, of an alternate embodiment of the package and the lead assembly;

FIG. 29 is the package and the lead assembly of FIG. 21 shown sealingly bonded to each other;

FIG. 30 is a side view, similar to FIGS. 1, 18 and 23, of another embodiment of a supercapacitor;

FIG. 31 is an end view of the supercapacitor of FIG. 30 with the lead assembly removed;

FIG. 32 is an enlarged fragmentary sectional view taken along line 32-32 of FIG. 31;

FIG. 33 is a side view, similar to FIGS. 1, 18, 23 and 30, of another embodiment of a supercapacitor;

FIG. 34 is a top view of the supercapacitor of FIG. 33;

FIG. 35 is a sectional view taken along line 34-34 of FIG. 19;

FIG. 36 is an exploded perspective view of the supercapacitor package of FIG. 33;

FIG. 37 is a side view of another embodiment of a supercapacitor;

FIG. 38 is an end view of the supercapacitor of FIG. 37;

FIG. 39 is a fragmentary sectional view of the supercapacitor taken along line 39-39 of FIG. 39;

FIG. 40 is a view similar to FIG. 39 with the lead assembly removed;

FIG. 41 is an underside view of a lead of the supercapacitor of FIGS. 37 to 39;

FIG. 42 is a side view of the lead of FIG. 41;

FIG. 43 is a schematic perspective view of a further package having a tubular body and two opposed rectangular end caps through which the respective leads sealingly extend outwardly from the body;

FIG. 44 is a perspective view of a further end cap suitable for use with the package of FIG. 43 and for providing a longer seal path between the body and the end cap;

FIG. 45 is a perspective view of a further end cap suitable for use with the package of FIG. 43 and which provide for an longer seal path between the body and the end cap and between the electrode and the end cap;

FIG. 46 is a perspective view of a further end cap suitable for use with the package of FIG. 43 and which provides an elongate lead;

FIG. 47 is a schematic perspective view of a further package including a single separate laminated end cap for captively and sealingly retaining the leads to provide for both long leads and a long seal path between the end cap and the leads;

FIG. 48 is a bottom view of the end cap of FIG. 47;

FIG. 49 is a cross-sectional view through the end cap of FIG. 47;

FIG. 50 is a schematic perspective view of a package to be formed from two LCP films;

FIG. 51 is a perspective view of lead for the package of FIG. 50, where the lead includes an LCP-aluminium seal that is pre-formed prior to inclusion of the terminal within the package; and

FIG. 52 is a schematic perspective view of the placement of the lead of FIG. 51 on one of the films of FIG. 50 prior to the two films being abutted and sealingly engaged with each other.

All the figures are for illustrative purposes only and are not necessarily to scale.

### PREFERRED EMBODIMENTS OF THE INVENTION

Throughout this specification, including the drawings, corresponding reference numerals will denote corresponding features on different embodiments.

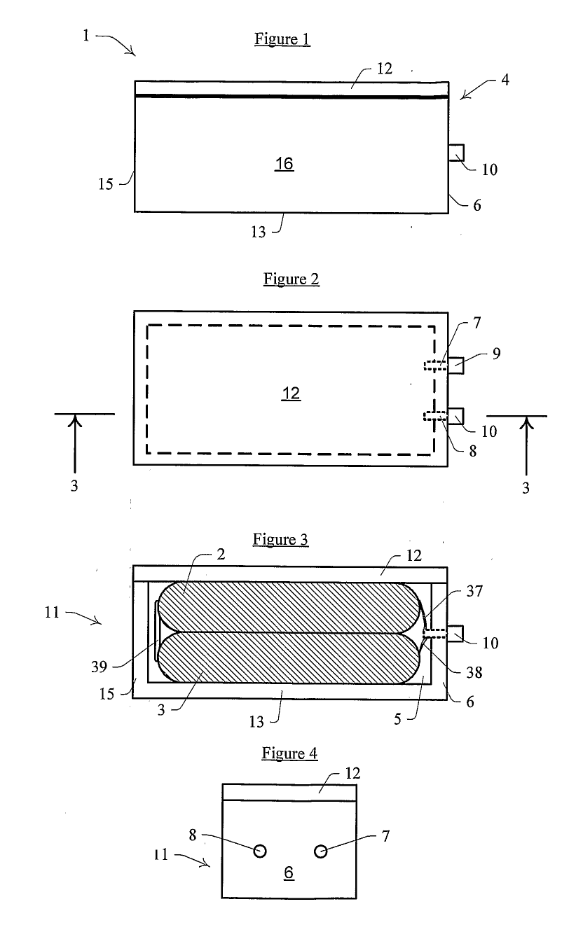

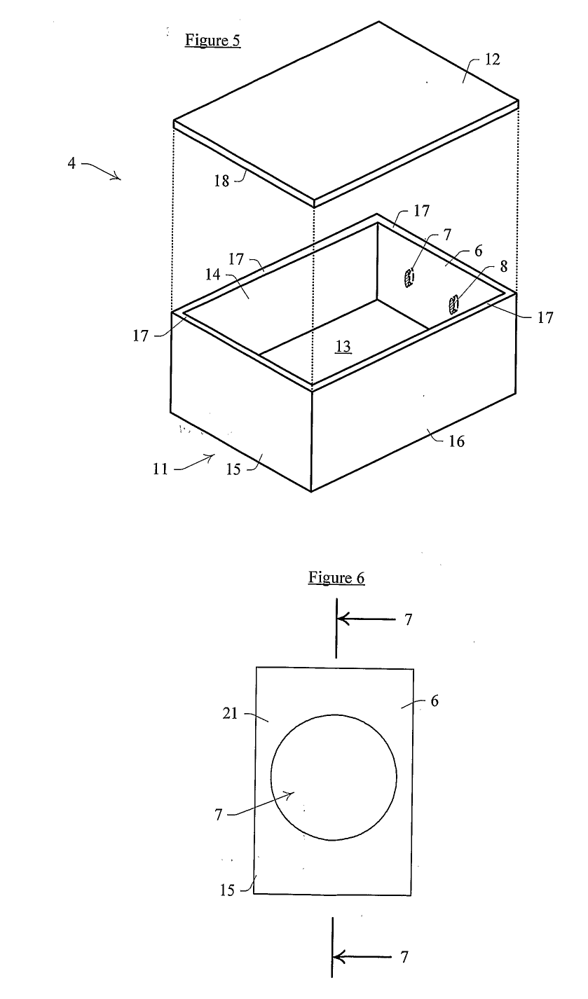

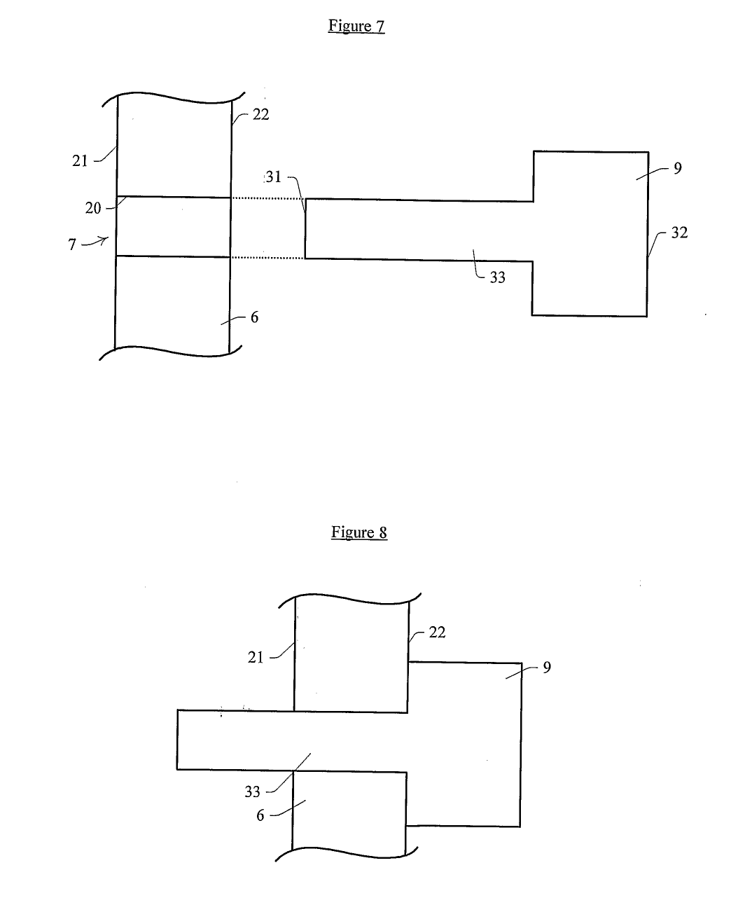

Referring to FIGS. 1 to 5, there is illustrated an electrical device, and in particular, an energy storage device in the form of a supercapacitor 1. The supercapacitor includes, as best shown in FIG. 3, an electrical element—which in this embodiment is an energy storage element—in the form of two like stacked supercapacitive cells 2 and 3 that are connected to each other in series. A two-piece generally prismatic sealed package 4 defines an interior 5 to contain cells 2 and 3. Package 4 includes a substantially planar access sidewall 6 having two spaced apart apertures 7 and 8 extending from interior 5 to an exterior of the package. Sidewall 6 contains a liquid crystal polymer (LCP) and, more particularly, is formed substantially entirely from LCP. A lead assembly, in the form of two spaced apart metal leads 9 and 10, are electrically connected to cells 2 and 3 respectively, and extend through respective apertures 7 and 8 to allow external electrical connection to the cells.

In some embodiments the access sidewall is formed from a laminate having a plurality of layers, where one or more of those layers is or includes LCP. In further embodiments, the access sidewall is substantially pure LCP. In still further embodiments, the access sidewall includes at least one interior coating and/or at least one exterior coating.

Cells 2 and 3 are formed from layers of aluminium coated with high surface areas carbon and separated by an ionically conductive but electrically insulating material such as porous plastic or paper. The aluminium layers are folded or rolled together or segmented and stacked: to define a positive electrode and a negative electrode; and, typically, to maximise the opposed surface area between the layers. Cells 2 and 3 are saturated in an electrolyte and can operate continuously at up to 3 Volts. In other embodiments different operating voltages are accommodated.

The electrolyte used in cells 2 and 3 is, in some embodiments, one or more salts dissolved in one or more non-aqueous solvents. For example, TEATFB dissolved in acetonitrile, TEMATFB dissolved in propionitrile, or the like. Other embodiments include an ionic liquid such as, for example, EMITFB, EMITFMS, EMITFSI, and the like. In further embodiments use is made of a salt dissolved in an organo-silicone, while in still further embodiments use is made of a mixture of two or more of the above.

More specific examples of electrolytes are disclosed in the International Patent Application having the publication no. WO 2007/101303 and the applicant's co-pending PCT application filed with the Australian Patent Office, in its capacity as an International Receiving Office, on the same date as the present application and entitled “A Charge Storage Device” (Attorney's reference 55816WOP00). The disclosure from these applications is incorporated into the present application by cross-reference.

Package 4 has the following transmission rates:

less than 1×10⁻¹³ cm³.cm/cm²/s/Pa for water vapour;

less than 1×10⁻¹⁴ cm³.cm/cm²/s/Pa for oxygen gas; and

less than 1×10⁻¹⁰ cm³.cm/cm²/s for the electrolyte.

In other embodiments different transmission rates are utilised. However, preferentially, the embodiments of the invention all achieve at least one of the following transmission rates:

less than 1×10⁻¹² cm³.cm/cm²/s/Pa for water vapour;

less than 1×10⁻¹³ cm³.cm/cm²/s/Pa for oxygen gas; and

less than 1×10⁻⁹ cm³.cm/cm²/s for the electrolyte.

Package 4 is collectively defined by a generally rectangular prismatic container 11 and a separate generally flat rectangular second sidewall 12. Container 11 includes a base 13 and four sidewalls 6, 14, 15 and 16 that extend upwardly from base 13 to collectively define a first continuous abutment surface 17. Apertures 7 and 8 are spaced apart from abutment surface 17 and substantially equally spaced between base 13 and surface 17. In other embodiments, use is made of alternative location and spacing of apertures 7 and 8. In a further embodiment at least one of apertures 7 and 8 are closely adjacent to abutment surface 17. In another embodiment, at least one of apertures 7 and 8 intersects with surface 17.

In a preferred embodiment, base 13 and sidewalls 6, 14, 15 and 16 are all integrally formed and substantively comprised of a like LCP.

In some embodiments package 4 is formed by means of injection moulding of the polymer. In other embodiments, package 4 is formed by means of press-moulding: In yet other embodiments package 4 is formed by means of injection-compression moulding.

In other embodiments, package 4 is machined into the desired form from a single block of the polymer. In some embodiments, the block is unformed prior to the machining, while in other embodiments the block is partially formed prior to the machining.

In some embodiments package 4 is constructed of partially formed polymer material such as sheet, film or block. In these embodiments, the sheet, film or block is itself preferentially formed from a series of layers of polymer film or sheet laminated together. In further embodiments utilising LCP, alternating layers of a harder LCP with a softer LCP, such as BONDPLY®, will allow the desired thickness of the final sheet, film or block to be achieved.

In those embodiments where package 4 includes a laminate, it is preferred that one or more of the layers in the laminate has at least one of the following characteristics: high thermal shielding; high thermal mass; and high rigidity. In some embodiments, each layer in the laminate provides preferentially for a subset of the required characteristics so that the laminate provides package 4 with the overall desired characteristics.

More specific examples of the desired thermal and other characteristics are disclosed in the applicant's co-pending PCT application filed with the Australian Patent Office, in its capacity as an International Receiving Office, on the same date as the present application and entitled “A Package for an Electrical Device” (Attorney's reference 55817WOP00). The disclosure from this application is incorporated into the present application by cross-reference.

Sidewall 12 includes a second abutment surface 18 that extends continuously about the periphery of the sidewall for complementarily engaging with surface 17. More particularly, in use, surfaces 17 and 18 are opposed with and bonded to each other to form sealed package 4. The bond between the abutment surfaces creates a hermetic seal and is achieved, in this embodiment, by one or more of laser welding, heat sealing or ultrasonic welding.

In other embodiments package 4 includes more than one access sidewall. For example, in some embodiments, one of apertures 7 and 8 is in sidewall 6, while the other of the apertures is in sidewall 15. In further embodiments, one or more of apertures 7 and 8, and the respective leads, extend through respective other sidewalls or the base. Another example includes those embodiments where device 1 is used with external balancing resistors. Particularly, device 1 includes two flexible aluminium tabs 37 and 38 that extend outwardly from respective cells 2 and 3 and which are welded or otherwise fixedly electrically engaged with respective leads 9 and 10. An interconnecting flexible aluminium tab 39 extends between cells 2 and 3 to electrically connect the two cells. The combination of tabs provides for a series connection of the cells, and for those serial connected cells to be electrically included within a circuit. The balancing resistors are usually two like resistors, one which is at least electrically and often also physically connected to both tabs 37 and 39, and the other which is at least electrically and often also physically connected to both tabs 38 and 39. In some embodiments, the balancing resistors are contained within interior 5. In other embodiments, the balancing resistors are contained within channels or cavities within one or more of the sidewalls or base, while in other embodiments the balancing resistors or printed, bonded or otherwise mounted to the interior surface of one or more of the base or sidewalls. In other embodiments, the one or more balancing resistors are printed, bonded or otherwise attached to the exterior face of one or more of the sidewalls or base, or a channel or other formation in those sidewalls or base.

In those embodiments where device 1 is designed to cooperate with separate balancing resistors, an additional like lead (not shown) is mounted in a complementary aperture in sidewall 15. That is, in these embodiments, sidewall 15 also defines an access sidewall. The additional like lead need only have a small cross section area for the typical current carried by the additional lead is low, certainly relative to the current carried by leads 9 and 10. The additional lead includes an interior end that is welded or otherwise electrically and physically engaged with tab 39, and an external end that is available for connection with external electrical components or circuitry.

In further embodiments container 11 includes other than four sidewalls. For example, in some embodiments the sidewalls are joined to each other by intermediate bevelled sidewalls, while in still further embodiments, use is made of five or more sidewalls.

In yet further embodiments, container 11 is non-prismatic. For example, in some embodiments container 11 includes at least one sidewall that is one of cylindrical; frusto-conical; or curved.

It will be appreciated from the teaching herein that package 4 is able to be designed to accommodate a given footprint or given dimensions for the supercapacitive cells and is not limited to accommodating the specific supercapacitive cells 2 and 3.

In some embodiments Cells 2 and 3 have a footprint of between about 5 millimetres×7 millimetres and about 36 millimetres×18 millimetres and a thickness of between about 0.1 millimetres and about 5 millimetres. Accordingly, the height of the stacked cells varies between about 0.2 millimetres and 10 millimetres and, given the thickness of sidewalls 6, 14, 15 and 16 are less than about 2 millimetres, the package 4 has a high footprint to thickness aspect ratio. In some embodiments of a supercapacitor or battery, the footprint is in the range of about 10 millimetres×10 millimetres and about 40 millimetres×20 millimetres. In some embodiments, the thickness of the package is in the range of about 0.5 millimetres to about 10 millimetres. In those embodiments where the package is for a MEMS device or an IC device, the footprint is often smaller in comparison to a supercapacitor or battery.

Package 4 has a height defined by the distance between the exterior of sidewall 12 and the exterior of base 13. In the FIG. 1 embodiment, this height is no more than about 5 millimetres. In other embodiments the height of package 4 is no more than about 0.5 millimetres.

In another embodiment the footprint of the device is no more than about 100 square millimetres (mm²). In a further embodiment the footprint of the device is no more than about 10,800 mm².

The thicknesses of base 13 and sidewalls 6, 14, 15 and 16 are substantially uniform and equal. More particularly, the thicknesses of the base and sidewalls are about 0.16 mm. In other embodiments alternative thicknesses are used. For example, in some embodiments sidewalls 6, 14, 15 and 16 are of greater thickness to provide additional load bearing capacity or greater heat insulation for cells 2 and 3. In other embodiments the thickness of the sidewall is less than about 0.11 mm. In other embodiments sidewall 6 is thicker than sidewalls 14, 15 and 16 to provide greater structural support to cater for the presence of apertures 7 and 8. The greater thickness of sidewall 6 also provides a long seal path length for apertures 7 and 8 to be sealed with respective leads 9 and 10.

In further embodiments the thickness of base 13 is different to the thickness of the one or more sidewalls.

The thickness of sidewall 12 is, in some embodiments, thicker than other sidewalls to provide additional thermal insulation to cells 2 and 3. Preferably, however, the thickness of sidewall 12 is no more than about 300 microns. Where device 1 is designed for a standard operating temperature range and for presently used surface mounting processes, the thickness of sidewall 12 is about 200 microns. In some embodiments sidewall 12 has a thickness of about 1 mm.

While the thickness of each sidewall shown in the Figures is substantially uniform, in other embodiments the thickness of one or more of the sidewalls varies at different parts of that sidewall. For example, in some embodiments, at least one of the sidewalls includes strengthening ribs. More preferably, those ribs are integrally formed with the sidewalls. In other embodiments, one or more of the interior surfaces of the sidewalls are contoured to complement the adjacent surface of the supercapacitive element or elements. Preferably also the contouring is asymmetric to facilitate automated orientation and placement of the supercapacitive element within the package. In further embodiments, one or more of the exterior surfaces of the sidewalls are contoured to complement, in use, an adjacent surface of another component, structural member, or circuit board.

A benefit of the package 4 is that it allows for the assembly of high aspect ratio electrical devices. These electrical devices have one or two dimensions substantially different to the others. In some embodiments the height to length or the height to width ratio, as given by dividing the length or width by the height, is between about 1 and about 80. In one embodiment of supercapacitor 1, the aspect ratio of height to length is 10 and in a second embodiment it is 40. Preferentially, the embodiments of the supercapacitors have an aspect ratio of more than about 10, and more preferentially, more than about 40.

The package includes a separation membrane (not shown) that electrically separates the stacked cells 2 and 3, specifically stopping the gross flow of electrolyte between cells. In embodiments where there is only one cell per package there is no separation membrane. In the preferred embodiments, the separation membrane is formed of an electrically non-conductive plastics material such as polypropylene, nylon or polyimide and has a thickness in the range of about 5 to 50 microns. In one specific embodiment the separation membrane has a substantially uniform thickness of about 15 microns. In other embodiments use is made of separation membranes of non-uniform thickness, while in further embodiments use is made of separation membranes that are corrugated or otherwise textured.

The design-bias for package 4 is to a minimal exterior volume. The exterior dimension of package 4 are driven by a number of factors, including the available footprint on the circuit board, the form and arrangement of the supercapacitive elements, and the required wall thickness of base 13 and sidewalls 6, 12, 14, 15 and 16 to deliver sufficient structural stiffness and sealing. More particularly, the wall thicknesses are usually one of the factors in defining the length of the sealing path, and for some sealants there is a need for longer sealing paths to prevent excessive diffusion of electrolyte out and water and oxygen in. As presently understood by the inventors, the practical minimum effective sealing path to achieve the desired sealing characteristics is about 1 mm for apertures 7 and 8 and about 200 microns for surface 17. However, this minimum will be dependent upon the materials used and the safety margin required. In other embodiments use is made of longer sealing paths. For example, in a specific embodiment the sealing path is 2 mm for apertures 7 and 8 and about 300 microns for surface 17.

In the preferred embodiments, the electrodes are formed from respective stacks of alternated aluminium sheets, where the sheets each provide a substantially equal active area to contribute to the capacitance of the supercapacitive cell. The footprint of this active area, together with the height of the stacks, are the key drivers for achieving a desired capacitance and ESR for the supercapactive cell and, hence, for the supercapacitor. Accordingly, the height of package 4 is dependant on the required height of the supercapacitor stacks for a given footprint. There is also a relationship between the footprint of a supercapacitor stack and the thickness required to meet predetermined ESR and capacitance values. As will be appreciated by those skilled in the art, the ESR varies primarily with electrode area, so a smaller footprint requires a proportionally larger number of layers in a given stack to maintain the same ESR. Capacitance, however, varies with the volume of the coating on the electrodes, so a smaller footprint is able to be at least partially compensated for by thicker coatings.

Of course in different embodiments different configurations are used to provide particular beneficial features. For example, in one embodiment a lesser capacitance or higher ESR is tolerated in favour of a device with lesser height or smaller footprint. In another embodiment, a thinner package sidewall is used in favour of a higher resistance to diffusion.

As shown in FIGS. 6 and 7, apertures 7 and 8 are defined by respective generally cylindrical aperture surfaces 20. While only aperture 7 and lead 9 are illustrated, it will be appreciated that aperture 8 and lead 10 are substantially identical. In other embodiments, apertures 7 and 8—and leads 9 and 10—are differently sized to accommodate differently sized leads to aid recognition of those leads during automated assembly of device 1 and any circuit device 1 is being used in.

Access sidewall 6 includes a substantially planar interior surface 21 and a substantially planar exterior surface 22 that is generally parallel with and opposite to surface 21. Surface 20 extends normally to and between surfaces 21 and 22. In use, lead 9 is sealingly engaged with surface 20. In other embodiments lead 9 is sealingly engaged with a combination of one or more of surfaces 20, 21 and 22.

For any given seal between two or more components, there is a path of minimum length between the two zones being sealed along which an impurity or other particle will have to traverse to defeat the seal. This path is referred to in this specification as the sealing path and is often specified in terms of the minimum length. Accordingly, for the FIG. 7 embodiment, the sealing path is at least the thickness of sidewall 6, as there exists a seal along the entirety of surface 20. For those embodiments where the seal extends beyond surface 20 the sealing path may be longer. This also assumes that where a sealant is used to affect the seal, that the transmission rates through the sealant per se is much less than any transmission through the interface between either of surface 20 and the sealant, on the one hand, and lead 9 and the sealant, on the other.

Sidewall 12, as shown, is substantially planar and peripherally sealingly engaged with surface 17. While the sealing face is substantially planar in this embodiment, in other embodiments the face is contoured, textured, or include one or more formations to facilitate the sealing engagement and to extend the sealing path. This will be described in more detail below.

Lead 9 includes an interior contact end 31 and an exterior access end 32 interconnected by an intermediate cylindrical shaft 33. Lead 9 is formed from aluminium, although in other embodiments alternative conductive materials are used such as copper, nickel, and alloys thereof. Shaft 33 of lead 9 is engaged with a respective surface 20 in an interference fit, and sealingly engaged with surface 20 by at least one of a bonding agent or adhesive.

As shown in FIG. 3, end 31 of lead 9 is electrically connected to tab 37, while end 31 of lead 10 is electrically connected to tab 38.

The engagement of shaft 33 with surface 20 provides for both:
A physical secure engagement to contribute to the overall robustness of package 4 and to allow it to be better suited to machine handling and manufacture.
A sealed engagement to reduce the risk of ingress of contaminants through apertures 7 and 8 into interior 5; and the egress of any fluids or other materials from interior 5 through apertures 7 or 8.

In one particular embodiment the sealed engagement between shaft 33 and surface 20 is contributed to by the use of a bonding agent. In the case of supercapacitors, batteries and hybrids of such energy storage device where a liquid electrolyte must be confined within the package 4, the bonding agent is substantially chemically resistant to the electrolyte. In other embodiments, adhesives that both seal and adhere are used to sealingly engage shaft 33 and surface 20. Examples of adhesives include the soft LCP product sold under the registered trade mark BONDPLY® and the product sold under the registered trade mark ARYLDITE® 64, amongst others. This bonding agent extends between shaft 33 and surface 20 and, once cured, provides for a hermetic seal. In other embodiments where no chemical resistance is required a broader range of bonding agents are available to provide the desired hermeticity.

In other embodiments, shaft 33 is other than cylindrical.

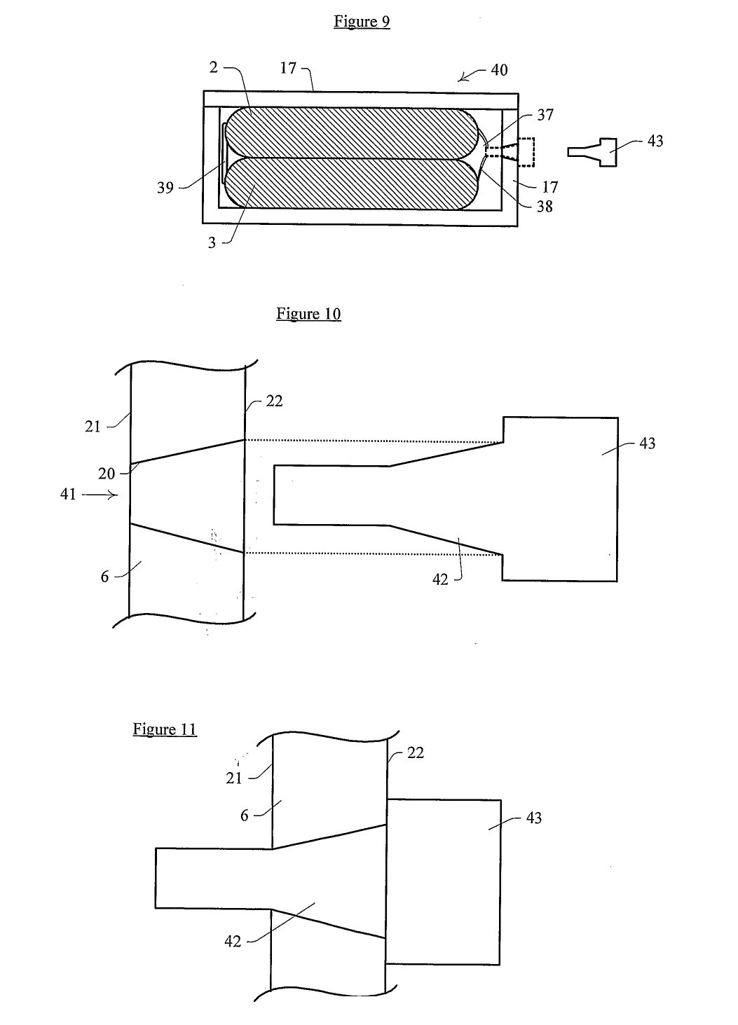

Reference is now made to FIGS. 9 to 11, where there is illustrated a package 40 having corresponding features denoted by corresponding reference numerals. Package 40 includes a frusto-conical aperture 41 in access sidewall 6 for complementarily receiving in an interference fit a shaft 42 of a lead 43.

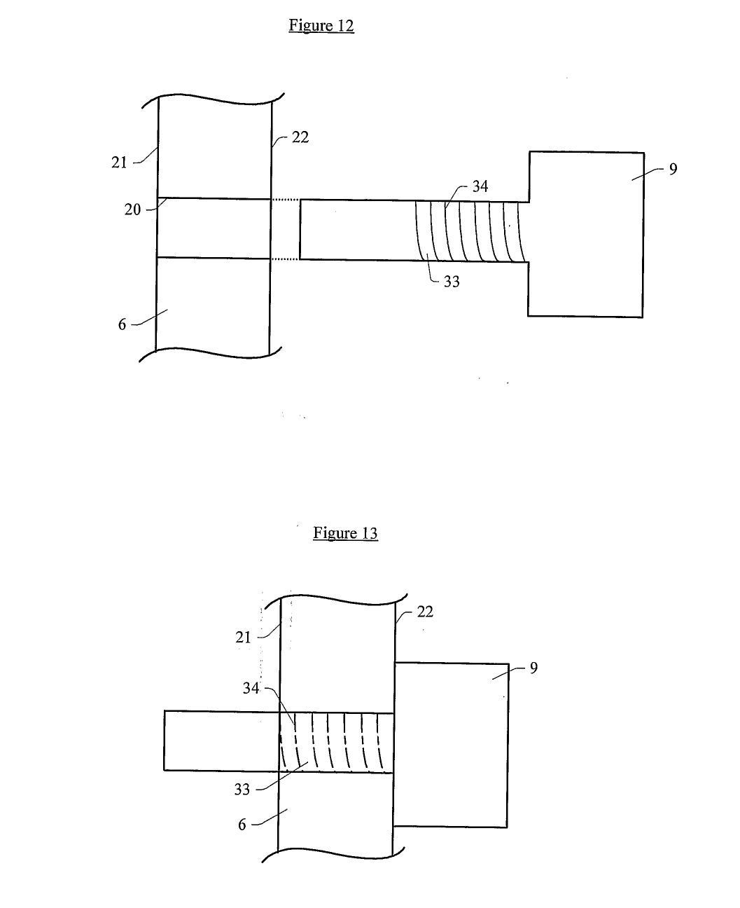

In another embodiment, as shown in FIGS. 12 and 13, shaft 33 is cylindrical and includes securing formations in the form of a threaded portion 34 for physically keying into surface 20 during construction to encourage a more intimate engagement between shaft 33 and surface 20.

In yet another embodiment, as shown in FIGS. 14 and 15, shaft 33 is frusto-conical and includes a threaded portion 34.

In other embodiments, use is made of an O-ring (not shown) to further provide for sealing engagement between lead 9 and one or more of surface 20 and surface 22. For example, and with reference to the FIG. 7 embodiment, an 0-ring is able to be received on shaft 33 and, in use, compressed between end 32 of shaft 9 and surface 22.

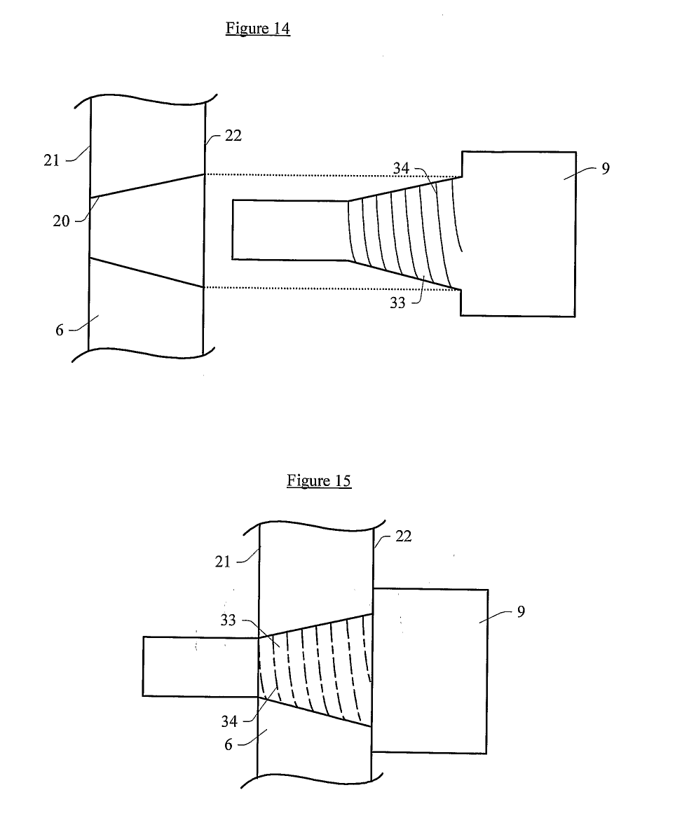

In another embodiment, illustrated in FIGS. 16 and 17, the lead assembly includes a sealant layer 50 to contribute to the sealing engagement between shaft 33 and surface 20. Layer 50 is pre-applied to shaft 33 of lead 9 and is an adhesive that bonds well to both package 4 and leads 9 and 10. In the present embodiment, where lead 9 is aluminium and sidewall 6 is LCP, layer 50 is one of BONDPLY® and ARALDITE® 64. However, in other embodiments alternative adhesives or combinations of adhesives are used.

In other embodiments, layer 50 is primarily a sealant as opposed to an adhesive, and the physical robustness of the seal is provided by others factors.

The lead assembly is fixedly mounted to package 4, in that leads 9 and 10 are bonded to respective surfaces 20 and otherwise engaged with those surfaces in an interference fit. In those embodiments where layer 50 is primarily a sealant, it is usual for leads 9 and 10 to include a further bond to physical fixedly retain leads 9 and 10 within respective apertures 7 and 8. The further bond is, in some embodiments, an adhesive bond between the lead and the package such as, for example, an adhesive bond between end 32 and surface 22. In other embodiments the bond is primarily mechanical, while in further embodiments use is made of welding or soldering.

While the bond provided by layer 50 in FIGS. 16 and 17 is a compound bond—in that it provides both a sealing bond and an adhesive bond between surface 20 and shaft 33—in other embodiments, the different bond types are provided by different bonding agents.

In some embodiments, use is made of leads that are pre-coated in LCP and, more preferably, pre-coating in a grade of LCP corresponding to that used in sidewall 6. Specifically, sheets, strips or tubes of aluminium are manufactured with a coating of LCP. This pre-coating is advantageous as the sealing of the leads and package will be between substantially like materials, similar to the package to package sealing of surfaces 17 and 18, which is generally easier to achieve.

In some embodiments, the leads are textured to improve adhesion to the LCP. Such texturing is achieved in one or more of a variety of ways, including by sand or grit-blasting, laser patterning or chemical etching.

Embodiments of the invention have also been developed for electronic devices that are exposed to high temperatures for short periods of time. Examples of such conditions include temperatures of up to 260° C. for up to several minutes. The packaging of those embodiments provides for—minimal heat impairment both of the electrical device contained within the package and the quality of the sealing properties of the package.

For electrical devices benefiting from large electrical contacts use is often made of leads with large cross-sectional area. This is particularly so for high current devices where there is a desire to contained I²R losses. It is, for some supercapacitors, also useful to have leads of this nature to reduce the effective ESR of the supercapacitor. It has been found by the inventors that a significant proportion of the heat that enters the interior of package 4 is conducted there via the leads, with high cross-sectional area leads typically conducting more heat. To contain the thermal conduction effect, while still gaining the lower resistance of leads having a large cross-sectional area, the shape and/or configuration of the leads are changed. In one embodiment, at least one of the leads is longer than the distance required to be bridged by the lead, which introduces a temperature gradient in the lead that reduces the effective heat transferred into package 4 and subsequently to either of cells 2 and 3. This reduces the risk of harm to the cells from the external heat.

It will be appreciated by those skilled in the art that a similar arrangement is able to be applied to leads of small cross-sectional area.

In these embodiments the lead follows other than a direct path and, in some cases, is bent back along its own length at least once to reduce the volume of space the lead requires. The bent or otherwise shaped portion of the lead is in some embodiments accommodated within the cavity defined by package 4 to both minimise the required space and to increase the length of the sealing path. In other embodiments, the bent or otherwise shaped portion of the lead is accommodated within one or more of sidewalls 6, 14, 15, 16 and 17 and base 13. In a subset of these embodiments, the portion of the lead within the sidewall and/or base also acts as a structural member to reinforce that sidewall and/or base.

In electrical devices where the electrical resistance of the lead is an important design factor, the temperature gradient effect of the lead and the additional electrical resistance contributed by making leads longer than electrically required is tailored to predetermined requirements by changing the cross-section and shape of the lead and the contact of the lead with the package and the device within the package. In some embodiments the shape of the lead varies between multiple cross-sections along it's length to contain the electrical resistance and reduce the heat ingress, while contributing more so to the hermeticity of the package.

For those embodiments where exposure to these elevated temperatures is a design feature, the electrical leads preferentially terminate outside the package in a lead that has a shape and position that minimises the amount of heat entering via the lead and maximising the electrical contact of the lead. In some embodiments, non-electrically required parts of the lead are coated to insulate that part of the lead from heat.

In a further embodiment the lead contains a thermal switch that isolates the device from heat entering via the lead.

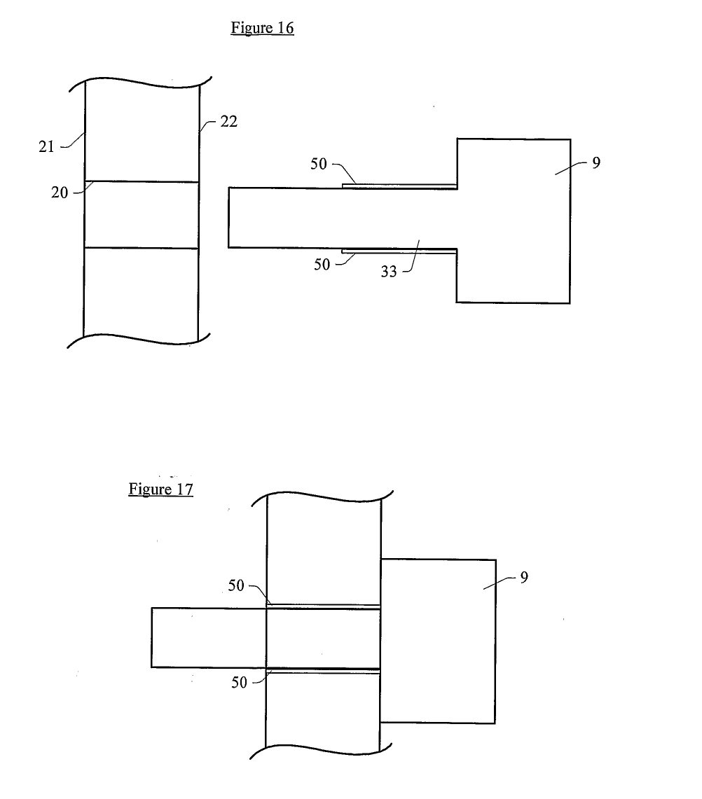

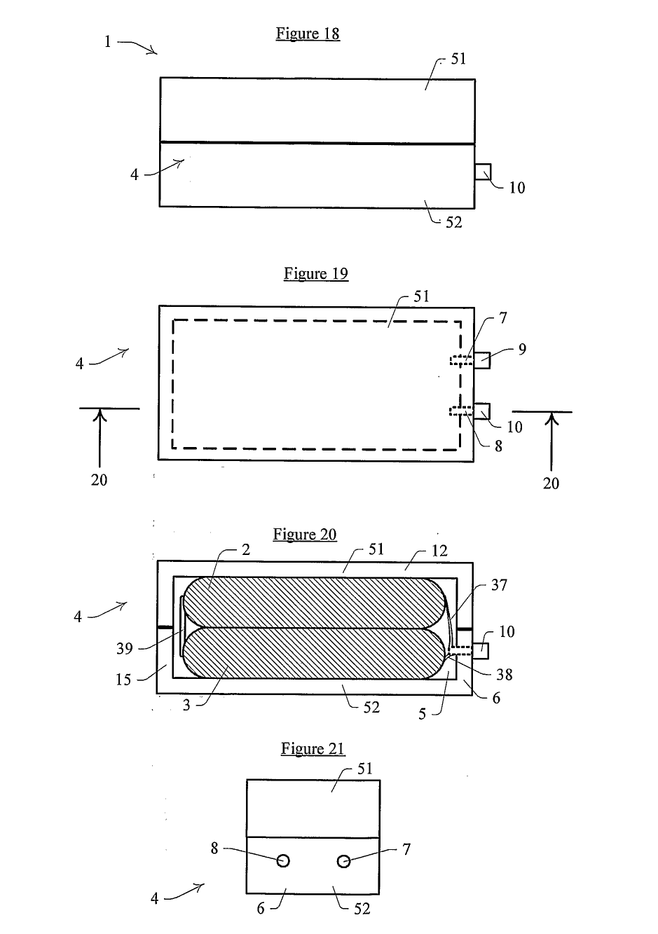

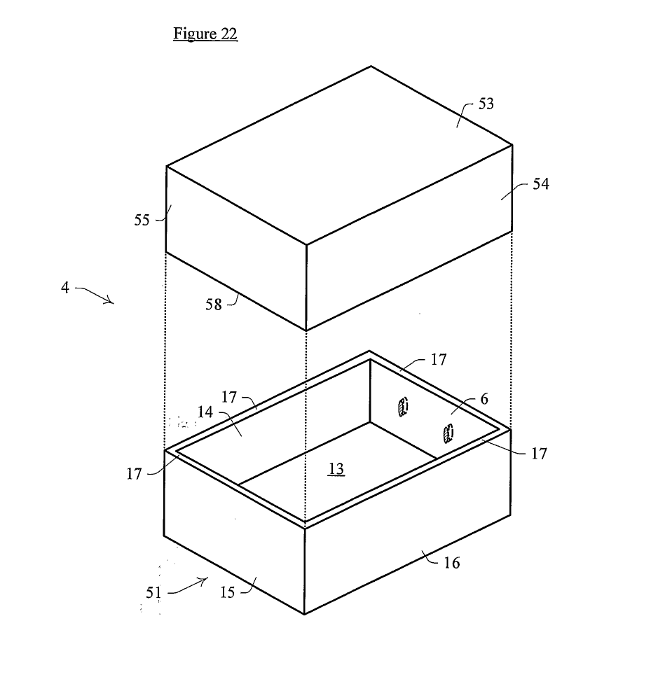

Another embodiment of the invention is illustrated in FIGS. 18 to 22, where corresponding features are denoted by corresponding reference numerals. In this embodiment, package 4 includes two like generally rectangular opposed prismatic containers 51 and 52. Container 51 is similar to container 11 of the package of FIGS. 1 to 5, in that it includes a base 13 and four sidewalls 6, 14, 15 and 16 that extend upwardly from base 13 to collectively define first continuous abutment surface 17. Container 52 includes a top 53 and four sidewalls 54, 55, 56 and 57 that extend downwardly from top 53 to collectively define a second continuous abutment surface 58. In use, containers 51 and 52 are arranged such that surfaces 17 and 58 are opposed and complimentarily abutted with and sealingly bonded to each other.

The bond between surfaces 17 and 58 is provided by a heat weld, although in other embodiments alternative bonds are used. Examples of alternative bonds include one or a combination of the following: laser welding; ultrasonic welds; mechanical locking; and a sealing membrane that is captively retained between the surfaces. Other examples include the use of bonding agents between the surfaces, such as one or more sealants or one or more adhesives, or a combination of both.

Preferably also, the bond creates a hermetic seal.

Apertures 7 and 8 are both included in container 52. In other embodiments, such as that illustrated in FIGS. 23 to 26, containers 51 and 52 each include one of apertures 7 and 8. The use of like containers 51 and 52 has manufacturing logistics advantages of one fewer components being required.

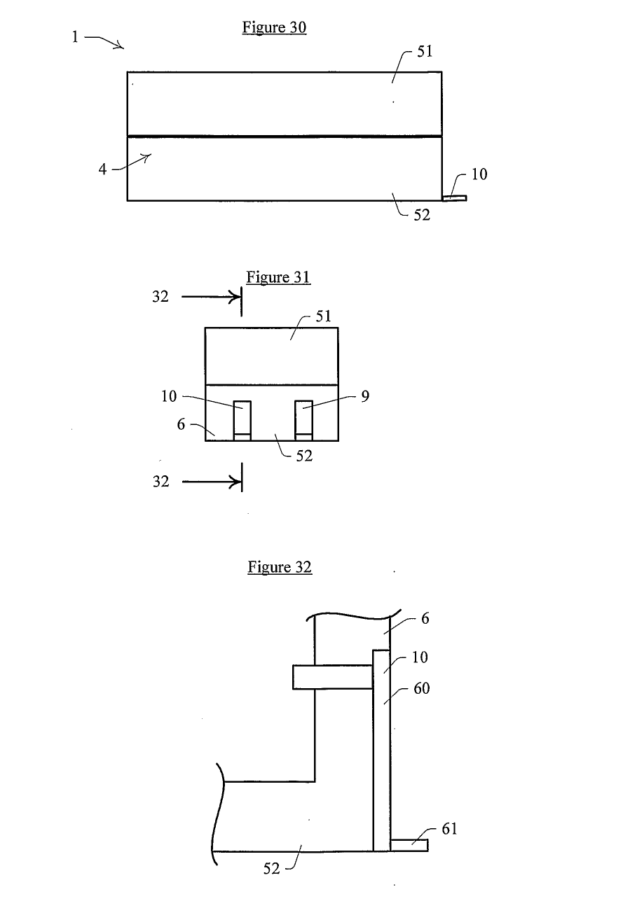

Another embodiment, illustrated in FIGS. 30 to 32, shows leads 9 and 10 in the form of two tabs. Referring particularly to FIG. 32, each tab includes a leg portion 60 that lies contiguous to sidewall 6 and a terminal 61 for providing an exterior contact point readily mountable to a flat surface (not shown). It will be appreciated that although FIG. 32 only shows lead 10, lead 9 includes like features.

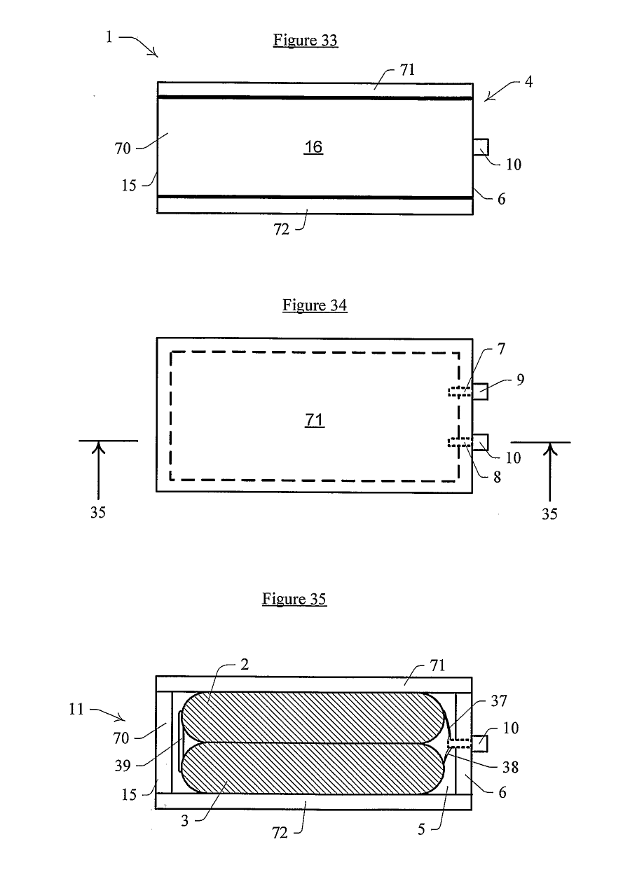

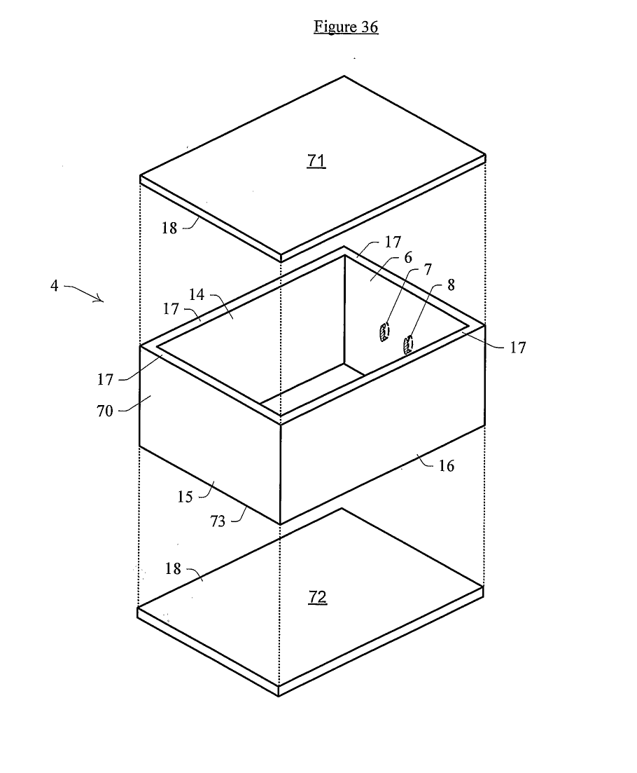

In another embodiment, illustrated in FIGS. 33, 34, 35 and 36, the sidewalls form an open-ended hollow central portion 70 and a pair of end portion sidewalls 71 and 72 are sealingly bonded to the central portion substantially covering the open ends. Sidewalls 71 and 72 include substantially identical features to sidewall 12, and portion 70 includes a bottom continuous abutment surface 73 that is substantially similar to surface 17.

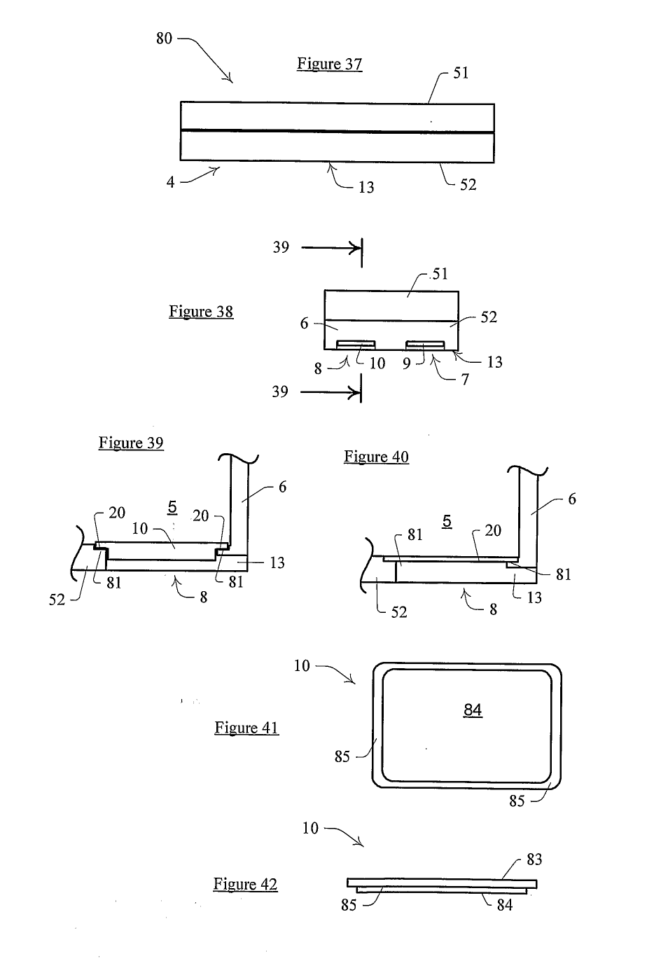

Reference is now made to FIGS. 37 to 42 where there is illustrated a further embodiment of invention in the form of a supercapacitor 80. This supercapacitor is has some similarities with the supercapacitors of FIG. 1 and FIG. 30 and corresponding reference numerals are used to designate corresponding features. More particularly, package 4 includes two opposed open-ended containers 51 and 52 that are sealingly engaged about the opposed abutment surfaces 17. The apertures 7 and 8 are formed in sidewalls 6 and 13 and each includes a locating formation, in the form of a continuous internal shoulder 81, for receiving respective leads 9 and 10. Each shoulder defines the sealing surface 20 for abutting with and sealingly engaging with the respective leads.

With particular reference to FIGS. 41 and 42, lead 10 is substantially rectangular flat aluminium tab having a generally planar upper surface 83 for partially defining the interior 5 and an opposite and smaller lower surface 84 which faces toward the exterior of package 4 and extends across all of aperture 8. A continuous and profiled sealing surface 85 extends between surface 83 and 84 for complementarily extending along and sealingly engaging with shoulder 81.

During manufacture, and prior to engagement of the opposed abutment surfaces, surface 20 is cleaned and otherwise prepared, and pre-coating with an adhesive or other bonding agent. Lead 10 is then progressed through the still open end of container 52 and surface 85 brought into engagement with the adhesive and surface 20. Once the adhesive cures, lead 10 is sealingly engaged with surface 20. It will be appreciated by those skilled in the art that lead 9 is installed across aperture 7 similarly. Following from this, the supercapacitive cell is inserted within container 52 and the cell terminals connected to leads 9 and 10. Container 51 is then sealed against container 52 to collectively define interior 5. A small section between the engagement surfaces is left unsealed to allow a port for ingress of the electrolyte. Once that ingress has occurred, the small port is sealed and the supercapacitor tested, marked and dispatched in accordance with the manufacturing process in place.

In other embodiments, surface 20 is not pre-coated and the manufacture is the same except that the sealing of surface 85 to surface 20 occurs simultaneously with the sealing of the opposed surfaces 17.

In some embodiments the flat tabs defining the leads are pre-coated to improve sealing to surface 20. Other embodiments include tabs that are otherwise shaped, and some of which are biased into engagement with the sealing surface by virtue of the resilient nature of tabs. In further embodiments, surface 20 is on a different sidewall, while in some embodiments it extends across more than one sidewall. Another embodiment includes outwardly facing surfaces 20 and flat tabs that are progressed into respective apertures and into engagement with those surfaces from the exterior such that face 84 defines partially interior 5.

While shoulder 81 and surface 85 are stepped, in other embodiments, use is made of different complementary profiles, such as a straight bevel, a curved bevel, a corrugation, or other such profile. It will be appreciated that more intricate profiles are able to be used to increase the sealing path, improve automated location of the tabs with respect to shoulder 81, and increase the manufacturing yield.

In further embodiments, the flat tabs are pre-coated with an adhesive and then slideably received within one or more channels (not shown) in one or more of the sidewalls prior to the adhesive curing.

In another embodiment the supercapacitive cell or cells is pre-welded or otherwise electrically connected with the leads, and the lead pre-coated with an adhesive, prior to insertion simultaneously of the cell and lead assembly into container 52.

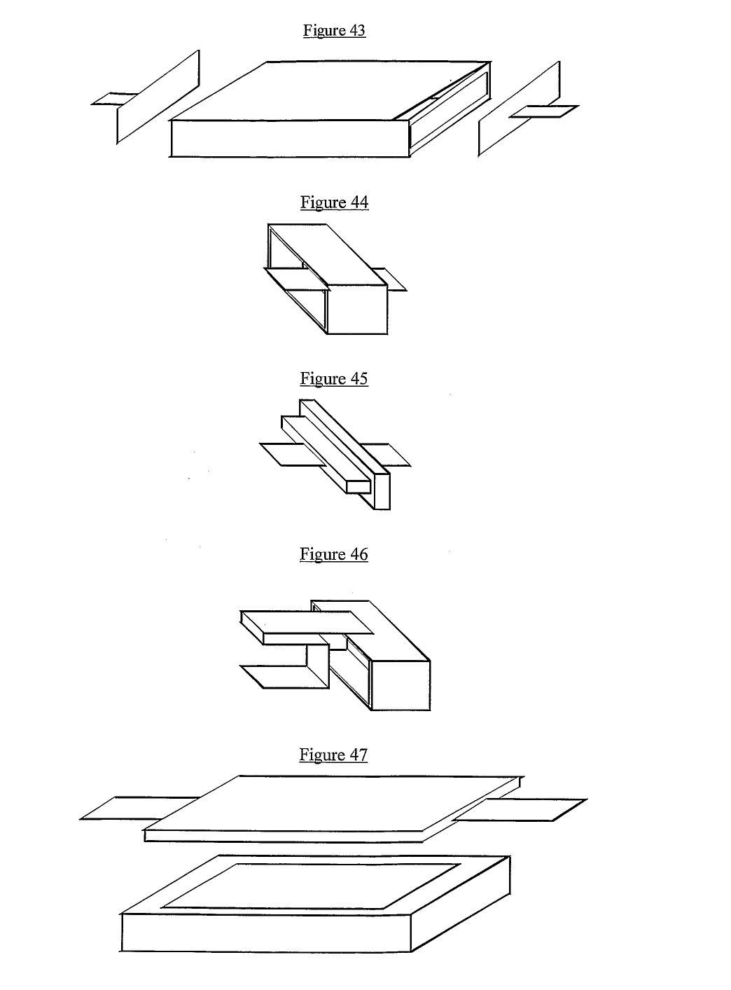

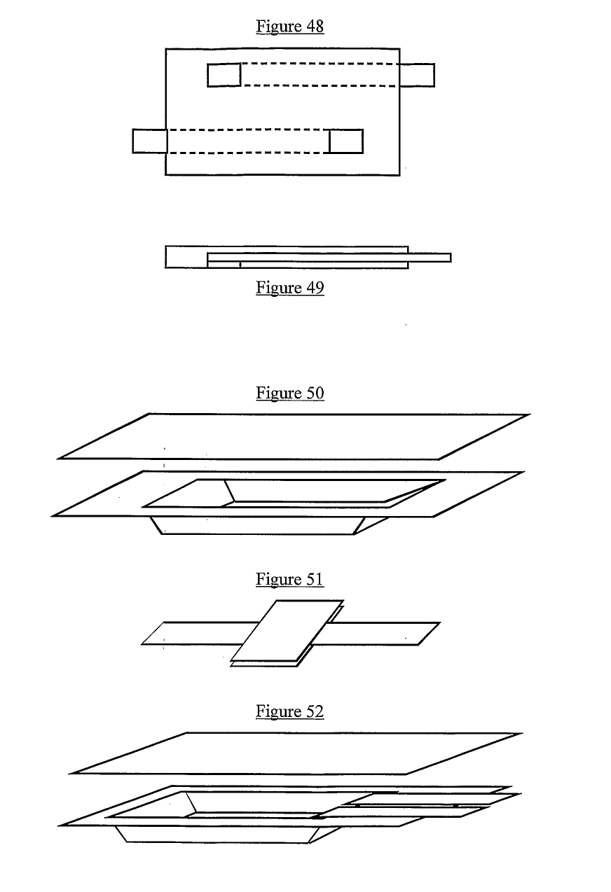

Reference is now made to FIG. 43 where there is illustrated another embodiment. This symmetrical tubular box package is able to be extruded and the ends formed for complementary engagement with the package. As shown in FIGS. 44, 45 and 46, variety of ends are available to provide for longer seal paths between the electrode and the ends, and between the ends and the package itself. This package also accommodates a variety of lead lengths and configurations.

Where particularly long seal paths are required, use is made of an embodiment such as that illustrated in FIGS. 47, 48 and 49.

In further embodiments, such as that illustrated in FIGS. 50, 51 and 52, the package is constructed from two opposed LCP films that have abutting flanges to provide long seal paths. The terminals extend outwardly from between the films.

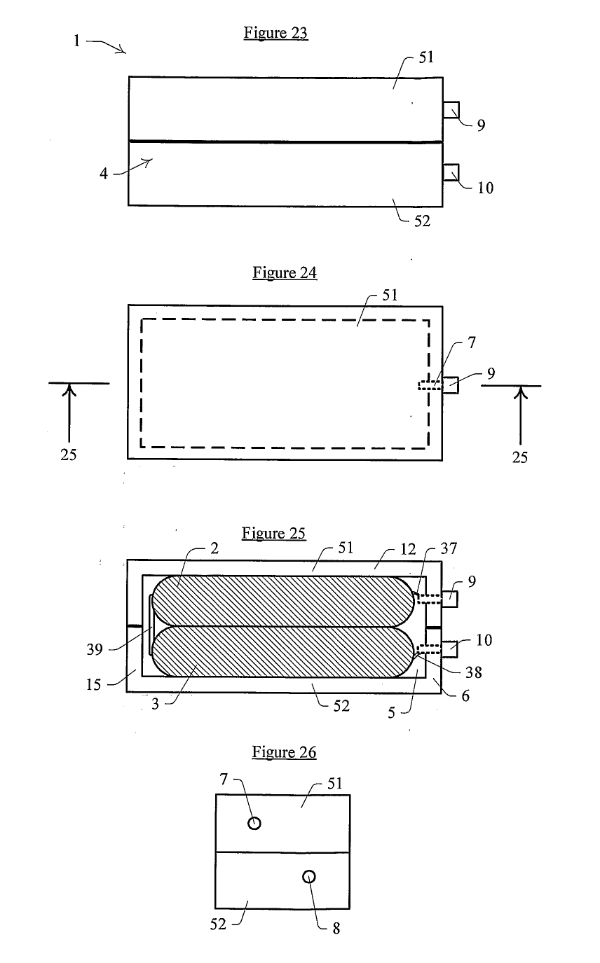

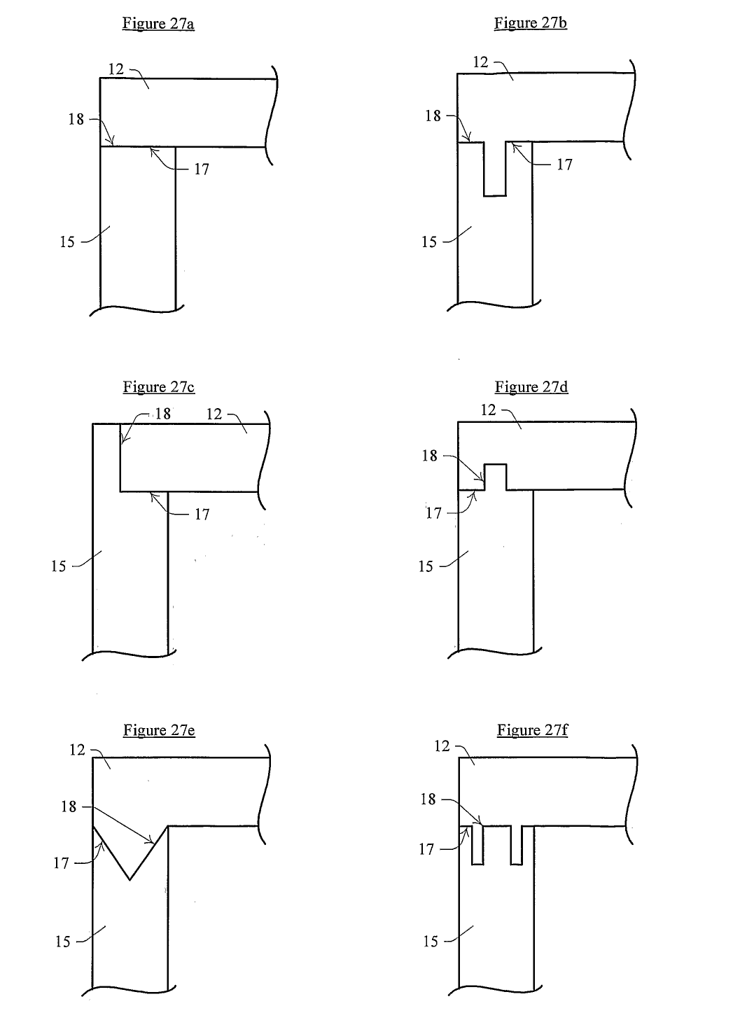

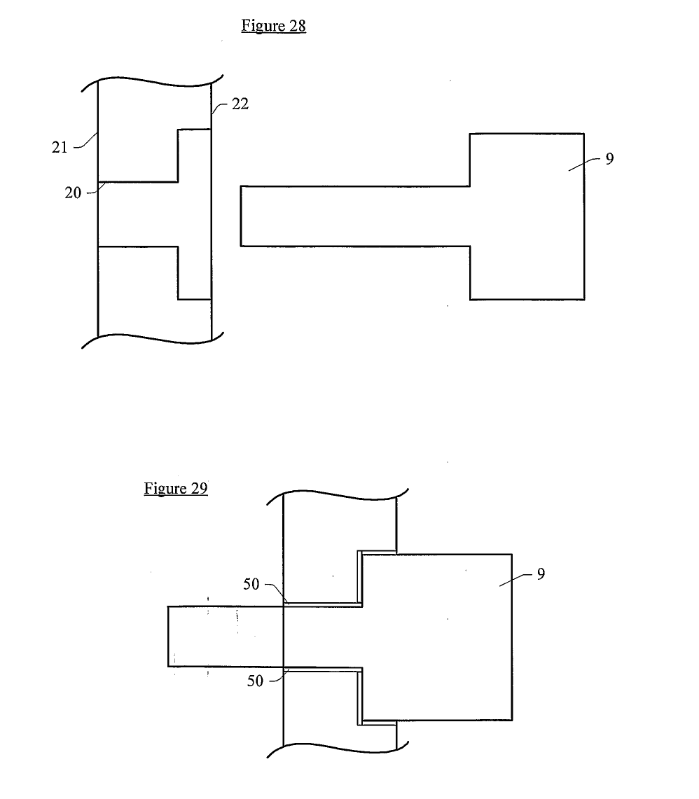

Reference is now made to FIG. 27a that illustrates in more detail the engagement of abutment surfaces 17 and 18 of the package of FIG. 1. It will be appreciated that surface 17 is defined b sidewall 15, and surface 18 is defined by sidewall 12. More particularly, and as shown in the Figure, both the abutment surfaces are substantially planar and the sealing engagement between the two surfaces is affected primarily by welding. In other embodiments at least one, and preferably both, of the abutment surfaces are non-planar. Even more preferably, the abutment surfaces are complementarily shaped.

Some examples of other abutment surfaces are illustrated in FIGS. 27b to 27f. In these embodiments both of sidewalls 12 and 15 include one or more complementary formations and, as a result, abutment surfaces 17 and 18 are non-linear. This increases either or both of the mechanical interlocking of the surfaces and the area of engagement between the surfaces. As the area increases the sealing engagement is typically more effective as any bonding agent has a greater area over which to create a sealing bond. Moreover, there is a greater path length for any contaminants to travel to traverse or penetrate the bond. The use of formations also has the advantage of aiding automated manufacture, as surfaces 17 and 18 are able to be positively located with respect to each other during that manufacture.

In the FIG. 27a embodiment, surfaces 17 and 18 are both textured by surface roughening to further facilitate the bond between those surfaces. In other embodiments alternative methods are used for texturing the surfaces, such as using a textured mould, sand or alumina grit-blasting, laser patterning or chemical etching. In some embodiments, only one of surfaces 17 and 18 is textured.

To further contribute to the bond between surfaces 17 and 18, both those surfaces are pre-treated to better accept and interact with an adhesive. More particularly, the pre-treatment includes corona treatment or flame treatment. In other embodiments, however, use is made of alternative or additional pre-treatments such as absorption and/or wetting. This is discussed further below.

While the sidewalls of package 4 are constructed substantially from LCP, in other embodiments use is made of other materials. For example in one embodiment the packaging material is poly-ether-imide (PEI). In another embodiment the packaging material is poly-ethyl-ketone (PEEK). LCP, PEI and PEEK all have preferential permeability, melting and structural characteristics and are therefore appropriate to this application. In further embodiments, different sidewalls are constructed from different materials.

Characteristics of the preferential material for package 4 include: high melting point or at least stability at elevated temperatures associated with automated manufacture of electronic components; good barrier to oxygen transmission; a good barrier to moisture transmission; and a good barrier to electrolyte transmission. It has been found that the above packaging materials, in combination with the bonding agents such as adhesives, provide these characteristics in the package.

LCP is a particularly appropriate material as it has the following beneficial properties, amongst others:
High thermal stability because of a Heat Deflection Temperature (HDT) of about 260 degrees Celsius. For some grades, the HDT is 280 degrees Celsius.
Low-melt viscosity.
Low permeability (this is discussed in more detail below) because of their high degree of molecular organisation.
Highly chemically inert and highly resistant to fire.
Low electrical conductivity

LCP is a preferred material for package 4, as it provides a much lower processing temperature than PEI and a much lower permeability to oxygen and water than PEEK.

The packages of the preferred embodiments provide transmission rates of less than 1×10⁻⁹ cm³.cm/cm²/s/Pa for water vapour and oxygen gas; and less than 1×10⁻⁹ cm³.cm/cm²/s for a liquid electrolyte. In some embodiments, the package need only provide one or two of these transmission rates. For example, where package 4 is to accommodate an electrical device that does not use an electrolyte—for example, a MEMS device—it is not required that the transmission rate for an electrolyte be met.

These transmission rates do not imply a loss mechanism and it is understood that the transmission rate for an electrolyte is for a liquid component of the electrolyte, such as: a solvent; component of a multi-phase solvent; or a liquid salt.

Where particular care is shown to creating the bonds between the abutment surface 17 and 18, on the one hand, and the leads 9 and 10 and respective surfaces 20, on the other, it is possible for the package to achieve one or more of the following transmission rates:

less than 1×10⁻¹² cm³.cm/cm²/s/Pa for water vapour;

less than 1×10⁻¹³ cm³.cm/cm²/s/Pa for oxygen; and

less than 1×10⁻⁹ cm³.cm/cm²/s for the liquid electrolyte.

In a specific embodiment, package 4 houses two supercapacitive cells which make use of acetonitrile as an electrolyte. In this embodiment, transmission rate of the electrolyte is less than 1×10⁻⁹ cm³.cm/cm²/s notwithstanding that acetonitrile is notoriously difficult to contain. Other embodiments include room temperature liquid salts (ionic liquids), liquid organo-silicones, propionitrile, propylene carbonate and other organic carbonates used as solvents for electrolytes.

A hermetic seal such as that provided by the preferred embodiments of the invention is an important factor in the performance and lifetime of electrical devices such as MEMS, IC's, supercapacitors and batteries. However, the embodiments of the invention are also applicable to other devices with electrical leads and a sensitivity to the atmosphere or those electrical devices containing a substance that has a tendency to escape and which, once escaped, impairs the performance of the device.

Unless the context clearly requires otherwise, the term “hermetic seal” as used in this specification is understood to mean a seal which is, for practical purposes, impervious to outside interference or influence by substantially limiting the escape or entry of gases and liquids over time.

Following below are some illustrative examples of the formation and testing of packages according to the invention.

### EXAMPLE 1

### Forming an Hermetic LCP Package

A 3 mm thick sheet of laminated LCP including alternate sheets of Ultralam® 3850 and Ultralam® 3908 is machined into a 28×20×3 mm open topped housing with a continuous abutment surface about the opening. The internal dimensions of the housing are about 24×16×2 mm. Two like housings are opposed such that the abutment surfaces are presented to each other and then heat sealed together with a 50 μm layer of Ultralam® 3908 captured between them. The seal is created by heating the opposed housings to 290° C. for 30 minutes with a spacer in the heating jaws to prevent over-compression. The package thus formed is cooled to 80° C. before removal from the heat sealer.

### EXAMPLE 2

### Forming an Hermetic LCP Package

A 3 mm thick sheet of laminated LCP including alternating sheets of Ultralam® 3850 and Ultralam® 3908 is machined into 28×20×3 mm housing similarly to Example 1. However, the abutment surface is defined by a lip surrounding the open top, where the lip is about 5 mm wide by about 1 mm thick. This provides for maximum external dimensions of about 38×30×3 mm. Two like housings are opposed and heat sealed together with a 50 μm layer of Ultralam® 3908 captured between them. The seal is created by heating the housings to 290° C. for 30 minutes with a spacer in the heating jaws to prevent over-compression. The package thus formed is cooled to 80° C. before removal from the heat sealer.

### EXAMPLE 3

### Testing the Hermeticity of an LCP Package

Packages as formed in Examples 1 and 2 were pierced by drilling a 0.5 mm diameter hole through the body of the package into the internal cavity. The cavity was filled with about 0.7 ml of either pure water or dry acetonitrile and the hole sealed by melting a small plug of LCP. The filled packages were then tested for hermeticity by heating to 70° C. and measuring weight loss over several weeks. No weight loss was detectable, verifying that the package thus formed has a permeability of less than 1×10⁻¹³ cm³.cm/cm²/s/Pa for water vapour and less than 1×10⁻¹⁰ cm³.cm/cm²/s for liquid acetonitrile.

### EXAMPLE 4

### Testing the Hermeticity of LCP to Aluminium Seals

Special cells made from aluminium with an hermetic valve for filling with liquids were sealed to 200 μm thick sheets of LCP, filled with water or acetonitrile and exposed to 85° C. with periodic monitoring of weight loss. The seal width was a 2 mm wide lip of sand-blasted aluminium. At 85° C. the vapour pressure of acetonitrile was sufficient to cause peeling of the seal area and thus occasional failure. To prevent this a physical support was used to prevent the ‘ballooning’ of the LCP sheet, reducing the subsequent peel strain on the seal. Using surface roughened aluminium heat sealed to sheets of either Ultralam® 3850 or Ultralam® 3908 showed both had a permeability to water vapour of about 1×10⁻¹² cm³.cm/cm²/s/Pa and a permeability to liquid acetonitrile equivalent to about 1×10⁻¹² cm³.cm/cm²/s.

### EXAMPLE 5

### Testing the Hermeticity of LCP to Aluminium Seals

Cells of the type used in Example 4 were used with adhesives to bond the LCP to the aluminium cell lip. All adhesive seals remained hermetic when the cell was filled with ionic liquid EMITFB. Adhesives used included: Loctite® UV cure acrylics 3924 and 3922; Loctite® UV cure epoxy 3335; Permabond® cyanoacrylate 922, and; Araldite® phenolic 64-1.

### EXAMPLE 6

### Testing the Barrier Properties of LCP

Films of LCP were measured for oxygen permeability in a Mocon Ox-Tran 2/21 at 1 atmosphere, 0% relative humidity and under standard operating conditions using standard Mocon masks for films. Measurements on 34 and 60 μm films of Ultralam® 3850 at 23° C. gave a permeability of about 2×10⁻¹⁷ cm³.cm/cm²/s/Pa and at 40° C. this was about 7×10⁻¹⁷ cm³.cm/cm²/s/Pa. A 70 μm thick film of Vectra 900 LCP (Ticona) formed by compression gave values of about 2×10⁻¹⁷ cm³.cm/cm²/s/Pa at 23° C. and about 6×10⁻¹⁷ cm³.cm/cm²/s/Pa at 40° C. Other similar films tested gave values of about 2×10⁻¹⁵ cm³.cm/cm²/s/Pa.

### EXAMPLE 7

### Testing the Hermeticity of LCP to Aluminium Seals

Films of LCP were laminated to both sides of aluminium foil and permeability along the seal interface was measured by cutting a partial hole through the multi-layer laminate, so that oxygen could pass freely perpendicularly through one external layer of LCP, but was prevented from further perpendicular movement by the solid and impermeable layer of aluminium. Any permeation measured is through lateral permeation through the LCP to aluminium bond. This permeation was measured using the Mocon as described in Example 6, but with permeation measurements allowed by cutting small holes in the edge of the underside of the Mocon mask. This allows lateral oxygen permeation to be measured. Laminates of 100 μm Ultralam® 3850 laminated to either face of 100 μm and 2.2 mm aluminium were tested in this manner and found to have oxygen permeabilities through the LCP to aluminium bond of between about 1×10¹⁴ cm³.cm/cm²/s/Pa and 5×10-¹³ cm³.cm/cm²/s/Pa.

### EXAMPLE 8

### Testing the Hermeticity of LCP to Aluminium Seals

Cells of the type used in Example 4 were used with adhesives to bond the LCP to the aluminium cell lip. All adhesives failed rapidly when the cell was filled with acetonitrile and all seals failed when the cell was filled with water. The failure rate with water was slower than that with acetonitrile, in some cases taking several days to fail. Adhesives used included: Loctite® UV cure acrylics 3924 and 3922; Loctite® UV cure epoxy 3335; Permabond® cyanoacrylate 922, and; Araldite® phenolic 64-1.

### EXAMPLE 9

### Testing the Hermeticity of LCP to Aluminium Seals

Cells of the type used in Example 4 were used with untreated aluminium bonded to the LCP film. The seal failed rapidly when the tested cell contained acetonitrile and the seal also failed when the cell was filled with water, albeit at a slower rate than that with acetonitrile, in some cases taking several days to fail.

### EXAMPLE 10

### Forming Bonds Between LCP and LCP 1

Tabs of 25 μm thick Ultralam® 3850 LCP were bonded to each other using various adhesives or laminating agents and immersed in dry acetonitrile (AN) at 70° C. A series of surface treatments were applied to the LCP surface to improve the dry seal strength. These included combinations of physical surface treatment, being either corona or flame treatment and/or chemical modification with: silanes (Dow Corning Z-6137); amines (TETA) and polyethylene imines (PEI) from BASF. A variety of conditions were tested for the surface treatments and the best results are given. Table 1 below summarises the peel strength of the bond before and after 3 days of immersion.

TABLE 1
LCP to LCP Seal Strength And Chemical Resistance

| | LCP | Peel strength (N/5 mm) | | |
|---|---|---|---|---|
| | surface | | 3 days in AN at | |
| Adhesive | treatment | Dry | 70° C. | Comment |
| UV cure acrylic | Chemical | 4 | 0 | Adhesive swells in AN |
| UV cure epoxy | Chemical | <1 | Not Tested | Insufficient strength |
| Cyanoacrylate | Chemical | 1 | 0 | Adhesive swells in AN |
| Phenolic | Chemical | 2 | 2 | Adhesive becomes brittle in AN |
| Ultralam ® 3908 | None | Did not | Did not fail | LCP internal cohesion failure, no |
| BondPly LCP | | fail | | bond failure |

### EXAMPLE 11

### Forming Bonds Between LCP and Aluminium

Tabs of 100 μm thick aluminium were bonded to tabs of 25 μm thick Ultralam® 3850 LCP using various adhesives or laminating agents and immersed in dry acetonitrile at 70° C. A series of surface treatments were applied to the aluminium surface to improve the dry seal strength. These included combinations of physical surface treatment, being either roughening, corona or flame treatment and/or chemical modification with: silanes (Dow Corning Z-6137); amines (TETA) and polyethylene imines (PEI) from BASF. A variety of conditions were tested for the surface treatments and the best results are given. The adhesives bonds were improved with chemical pre-treatment of the aluminium, while the heat seal Ultralam® LCP materials were improved by surface roughening of the aluminium. Table 2 below summarises the peel strength of the bond before and after 3 days of immersion.

TABLE 2
LCP to aluminium seal strength and chemical resistance

| | | Peel strength | | |
|---|---|---|---|---|
| | | (N/5 mm) | | |
| | | | 3 days in | |
| | Al surface | | AN at | |
| Adhesive | treatment | Dry | 70° C. | Comment |
| UV cure acrylic | Chemical | 5 | 0 | Adhesive swells in AN |
| Cyanoacrylate | Chemical | 6 | 0 | Adhesive swells in AN |
| Phenolic | Chemical | 2 | 2 | Adhesive becomes |
| | | | | brittle in AN |
| Ultralam ® 3908 | Scotch | 3 | Not | 2.5 after 5 days in |
| BondPly LCP | Brite | | Tested | AN at 70° C. |
| Ultralam ® 3850 | Scotch | 5 | Not | 4.5 after 5 days in |
| LCP | Brite | | Tested | AN at 70° C. |
| Ultralam ® 3908 | Sand | 4 | 4 | No deterioration after |
| BondPly LCP | blasted | | | 5 days in AN at 70° C. |
| Ultralam ® 3850 | Sand | 8 | 8 | No deterioration after |
| LCP | blasted | | | 5 days in AN at 70° C. |

In some embodiments the reduced transmission rate for a given substance is due to the selection of the materials to be bonded together, or the pre-treatment of the surfaces to be bonded to each other, or both. For example in one embodiment, wetting is a used as a pre-treatment for abutment surfaces 17 and 18. The effectiveness of wetting is achieved by ensuring that the surface energy of the abutment surface is higher than the surface tension of the liquids and adhesives brought into contact with the abutment surface. Wetting effectiveness is additionally improved by designing the surface chemistry of the abutment surface so that acid-base and Van der Waals interactions between adhering materials are maximised.

In another embodiment adhesion is improved by maximising the degree of surface roughness. This in turn may facilitate mechanical interlocking of cured adhesive with the abutment surface exhibiting convoluted surface geometry.

In further embodiments use is made of one or more methods of surface cleaning to substantially free the bonding surfaces of contaminants, grease amongst others. The more usual methods of surface cleaning utilise one or more organic solvents such as acetone, methyl ethyl ketone (MEK), isopropanol, methanol and a variety of proprietary cleaning liquids. The methods of surface cleaning include applying the solvents at a cleaning station through one or more of: surface wiping; immersion; spraying; vapour degreasing; and ultrasonic bath cleaning. In those embodiments where particularly low transmission rates are required, care is taken when using the wiping method to ensure any contaminants are actually removed from the surface rather than being simply redistributed along the surface.

Once the abutment surfaces are cleaned they are progressed immediately to a bonding station to minimise the danger of contaminating the surfaces by either or both of: adsorption of organic volatile compounds; or migration of low-molecular weight functional additives present in most polymeric materials.

In some embodiments one or more of the abutment surfaces have their respective chemistry modified to enhance the quality of the bonding and, ultimately, to reduce the transmission rate for the package as a whole. For example in one embodiment, all the abutment surfaces are treated with corona discharge to modify those surfaces.

In another embodiment, flame treatment is used to modify surface chemistry and thereby enhance seal quality. In this treatment, the tip of an oxygenated laminar flame is utilised to oxidise a surface. Flame treatment is typically carried out with a stoichiometric air/propane mixture exhibiting 1% to 2% oxygen excess in the after burn mixture. Depending on the type of package material and treatment requirements, the treatment distance between the flame tip and abutment surface is adjusted from about 5 mm to 130 mm. The residence time of the surface in the treatment zone is typically less than a few seconds.

In similarity to corona discharge treated polymers, the flame-treated polymeric surfaces contain increased quantity of hydroxyl-, carboxyl- and other oxygen-containing groups which increase their surface energy and improve wettability and consequently adhesion.

In yet another embodiment, plasma treatment is used to modify the chemistry of one or more of the abutment surfaces. Plasma treatment functionalises the surface of polymers by exposing their surface to ionised gases—for example, air, oxygen, nitrogen, ammonia, etc.—under vacuum pressure. In this process, the plasma reactor containing the treated substrate needs to be evacuated to a required level of vacuum. Once a constant chamber pressure is achieved, plasma is generated by an oscillator operating at a specific frequency, for example, MW or RF at a controlled power input and desired length of time, typically 5 seconds to 60 seconds. The reaction gas, for example oxygen, nitrogen or ammonia, may be subsequently fed into the reactor at a controlled flow rate. Oxygenated, amine, amide or other type of surface functionalities are created on the polymer surface following exposure to the plasma irradiation.

The process rate can also utilise polymerisable monomers or gases under ionised plasma condition and deposit, or graft a new polymer layer on the abutment surface through so-called plasma polymerisation process. The new surface layer exhibits structure differing from that of the virgin polymer, generally highly cross-linked. Various surface functionalities can also be created through the use of plasma polymerisation.

Excimer laser treatments are a relatively new method for modifying the abutment surface for enhanced adhesion. In this method, a high-energy pulse of a laser beam (for example, ArF emitting short-wave UV radiation of about 193 nm) is applied to the abutment surface.

The application of a laser beam at energy levels below that of polymer ablation threshold leads to a controlled chemical modification or creates an amorphous surface zone on an initially crystalline or semi-crystalline polymer. The typical phenomena induced by removal of contaminants and weak boundary layer, modification of surface chemistry through the introduction of surface hydroxyl and carboxyl groups, and depending on the energy output and intensity: surface amorphisation or cross-linking.

It has also been observed that excimer laser treatment under an inert gas blanket (for example argon) provides a mechanically stable interphase with high cohesive strength, whilst treatment in ambient air has lead to the creation of a brittle surface.

Surface functionalisation by combined surface oxidation and chemical grafting—many types of untreated (as received) thermoplastic polymers, such as polyolefines, LCPs, polyphenylene sulphone, polyetherimides, and PEEK are chemically inert and are not reactive with adhesive, paints or printing inks due to the absence of required chemical functionalities at their surface. The degree of difficulties concerning adhesion is significantly increased with an increasing level of surface crystallinity.

In various embodiments, various methods of bonding are used between surfaces 17 and 18. In some embodiments these methods are used after one or more of the above surface treatments is carried out.

For example, in one embodiment, the method of dual resin bonding is used. Dual resin bonding, also known as film stacking, involves inserting a polymer interlayer with the melting point below that of the abutment surfaces 17 and 18 (for example, BONPLY®). The entire area is then heated to the melting point temperature of the polymer interlayer. The resulting strength of the bond results from the interface fusion, and can be additionally enhanced through inter-diffusion of macromolecular chains present in both materials.

Bulk heating techniques require that the bond-line be free of any foreign material and the strength of a bonded structure can equal that of the package material.

It is appreciated that, in other embodiments, methods of bonding of abutment surfaces 17 and 18 other than heat sealing or ultrasonic welding are utilised. In two specific embodiments, these alternatives respectively include induction welding and lamination. Other examples of alternative bonds include heat welding, mechanical locking and a sealing membrane that is captively retained between the surfaces, amongst others. Some embodiments use bonding agents between the surfaces, such as one or more sealants or one or more adhesives, or a combination of both.

Fusion bonding, particularly IR or laser assisted fusion-bonding techniques, are used in some embodiments to meet the requirements of strong bonding between components and the rapid manufacture and assembly of the device. Other examples of fusion bonding include vibration welding, spin welding and hot gas welding, amongst others.

Fusion bonding and welding are advantageous for, amongst others, the following reasons:
Minimum surface preparation requirements.
Joint strength approaches that of the bulk polymer.
Minimal processing time.

In some embodiments, use is made of a near infra-red (NIR) laser to create a fusion bond. One such bond is formed between two LCP surfaces that are both partially transparent to the NIR laser with the addition of a laser absorption compound placed between the bonding surfaces. In other cases two dissimilar LCP materials are used, one partially transparent to the NIR laser and the second mostly absorbent. In each case the structure around the surfaces to be bonded is designed to maximise the efficiency of the laser fusion bond. In these embodiments there is also the option to use NIR laser welding to seal the LCP to the aluminium terminal. In this case no laser absorbing compound is required.

Embodiments of the invention improve the adhesion of LCP by the following four steps:
Treatment by Corona discharge, as described above.
Applying a 10% to 45% aqueous acrylic dispersion (Rohm & Haas: Rhoplex AC 201 cross-linkable acrylic coating) onto the surface of corona-treated LCP.
Drying coated films at 100 degrees Celsius.
Heating the LCP above its melting point during lamination with another material.

It is appreciated that in other embodiments, other process steps are used to improve the adhesion of LCP.

In some embodiments, use is made of a thermal insulator within interior 5 of package 4. One such insulator is a PCM:silicone mix. This and other insulators, and their functions, are disclosed in the co-pending PCT application filed with the Australian Patent Office, in its capacity as an International Receiving Office, on the same date as the present application and entitled “A Package for an Electrical Device” (Attorney's reference 55817WOP00). As mentioned above, the disclosure within that application is incorporated herein by way of cross-reference.

The embodiments of the invention described herewith include two types of hermetic seal:
Package-to-package.
Lead-to-package.
The use of two types of hermetic seal for the above applications is advantageous because:
A specific type of sealant or method of sealant is able to be used to provide a better seal between two particular sealing surfaces.
In general terms, hermetic seals are able to be more easily achieved when sealing like materials to each other. Accordingly, the larger seal—that is, the more likely zone of sealing weakness—is formed in the embodiments between like package materials.
Different types of bonding are able to be used to create the required seals based upon not only the materials being bonded, but also the requirements for mechanical strength, the path length of the seal, the manufacturing process, the cost of materials, and others.

It is appreciated that the embodiments of the invention described are able to be used within many different applications. Additionally, some embodiments of the invention are designed for use in a particular or specific application while others are design more generically for one or more of a variety of applications.

Examples of applications where the electrical device is a supercapacitor include:
Wireless communications with limited power supplies such as: mobile/cellular telephones; PC card; CF card; mini PCI; express card; USB modems; PDA's; automatic meter reading; toll tags; GPS, GPRS and RF tracking.
Energy back-up (UPS) in portable, or space constrained devices.
Voltage regulation for CPU's; automotive vehicles and other devices with high surge loads.
High energy, high power electrical loads, such as: actuators for door locks; DSC's; LED flashes for cameras.
Solid state memory storage devices (for example, solid state hard drives).

A supercapacitor using the package as herein described is advantageous over other technologies for, amongst others, the following reasons:
Relative sidewall thickness is less than existing devices, therefore providing a smaller footprint for the supercapacitor.
Relatively inexpensive to manufacture due to the individual items have simple shapes and are able to be assembled in a mass manufacturing process.
Is able to be manufactured at relatively high volumes (10's of millions per month).
Accommodates a wide variety of possible wall or device thickness.
Allows for a large contact area between the lead and the package.
Accommodates a wide range of storage element dimensions and thicknesses. For example, for a given footprint it is possible to easily provide packages of different heights to accommodate elements having differing numbers of layers.
Allows for reflow soldering.
Allows for multiple cells in a single package.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention has been described with reference to specific examples, it will be appreciated by those skilled in the art that it may be embodied in many other forms. In particular, features of any one of the various described examples or embodiments may be provided in any combination in any of the other described examples or embodiments.

1-23. (canceled)

24. A package for an energy storage device having an energy storage element and at least two leads for allowing electrical connection to the element, the package including:
a plurality of sidewalls for defining an interior to contain the energy storage element and a liquid electrolyte, wherein at least one of the sidewalls is formed from liquid crystal polymer (LCP);
a mounting formation defined by one or more of the sidewalls for locating the leads to extend from the interior to an exterior of the package, wherein the package has one or more of the following transmission rates:
less than 1×10⁻¹² cm₃.cm/cm2/s/Pa for water vapor;
less than 1×10⁻¹³ cm3.cm/cm2/s/Pa for oxygen gas; and
less than 1×10⁻⁹ cm3.cm/cm2/s for the electrolyte.

25. A package according to claim 24 having two or more of the following transmission rates:
less than 1×10⁻¹² cm3.cm/cm2/s/Pa for water vapor;
less than 1×10⁻¹³ cm3.cm/cm2/s/Pa for oxygen gas; and
less than 1×10⁻⁹ cm3.cm/cm2/s for the electrolyte.

26. A package according to claim 25 having the transmission rates of:
less than 1×10⁻¹² cm3.cm/cm2/s/Pa for water vapor;
less than 1×10⁻¹³ cm3.cm/cm2/s/Pa for oxygen gas; and
less than 1×10⁻⁹ cm3.cm/cm2/s for the electrolyte.

27. A package according to claim 24 having one or more of the following transmission rates:
less than 1×10⁻¹³ cm3.cm/cm2/s/Pa for water vapor;
less than 1×10⁻¹⁴ cm3.cm/cm2/s/Pa for oxygen gas; and
less than 1×10⁻¹⁰ cm₃.cm/cm2/s for the electrolyte.

28. A package according to claim 27 having two or more of the following transmission rates:
less than 1×10⁻¹³ cm3.cm/cm2/s/Pa for water vapor;
less than 1×10⁻¹⁴ cm3.cm/cm2/s/Pa for oxygen gas; and
less than 1×10⁻¹⁰ cm3.cm/cm2/s for the electrolyte.

29. A package according to claim 28 having the following transmission rates of:
less than 1×10⁻¹³ cm3.cm/cm2/s/Pa for water vapor;
less than 1×10⁻¹⁴ cm3.cm/cm2/s/Pa for oxygen gas; and
less than 1×10⁻¹⁰ cm3.cm/cm2/s for the electrolyte.

30. A package according to claim 24 wherein the energy storage device is a supercapacitor.

31. A package according to claim 30 wherein the supercapacitor includes at least one supercapacitive cell, where each cell includes at least one pair of opposed electrodes, a non-conductor separator between the electrodes, and terminals for electrically connecting the electrodes to the leads.

32. A package for an energy storage device having an energy storage element and at least two leads for allowing electrical connection to the element, the package including:
a plurality of sidewalls for defining an interior to contain the energy storage element and a liquid electrolyte;
a formation defined by one or more of the sidewalls for locating the leads to extend from the interior to an exterior of the package, wherein the package is substantially rigid and has one or more of the following transmission rates:
less than 1×10⁻¹² cm3.cm/cm2/s/Pa for water vapor;
less than 1×10⁻¹³ cm3.cm/cm2/s/Pa for oxygen gas; and
less than 1×10⁻⁹ cm3.cm/cm2/s for the electrolyte.

33. A package according to claim 32 having two or more of the following transmission rates:
less than 1×10⁻¹² cm3.cm/cm2/s/Pa for water vapor;
less than 1×10⁻¹³ cm3.cm/cm2/s/Pa for oxygen gas; and
less than 1×10⁻⁹ cm3.cm/cm2/s for the electrolyte.

34. A package according to claim 33 having the following transmission rates:
less than 1×10⁻¹² cm3.cm/cm2/s/Pa for water vapor;
less than 1×10⁻¹³ cm3.cm/cm2/s/Pa for oxygen gas; and
less than 1×10⁻⁹ cm3.cm/cm2/s for the electrolyte.

35. A package according to claim 32 wherein the package has one or more of the following transmission rates:
less than 1×10⁻¹³ cm3.cm/cm2/s/Pa for water vapor;
less than 1×10⁻¹⁴ cm3.cm/cm2/s/Pa for oxygen gas; and
less than 1×10⁻¹⁰ cm₃.cm/cm2/s for the electrolyte.

36. A package according to claim 35 having two or more of the following transmission rates:
less than 1×10⁻¹³ cm3.cm/cm2/s/Pa for water vapor;
less than 1×10⁻¹⁴ cm3.cm/cm2/s/Pa for oxygen gas; and
less than 1×10⁻¹⁰ cm3.cm/cm2/s for the electrolyte.

37. A package according to claim 36 having the following transmission rates:
less than 1×10⁻¹³ cm3.cm/cm2/s/Pa for water vapor;
less than 1×10⁻¹⁴ cm3.cm/cm2/s/Pa for oxygen gas; and
less than 1×10⁻¹⁰ cm3.cm/cm2/s for the electrolyte.

38. A package for an energy storage device having an energy storage element and at least two leads for allowing electrical connection to the element, the package including:
a plurality of sidewalls for defining both an interior to contain the energy storage element and a liquid electrolyte and a mounting face having a footprint of a predetermined area, wherein the package has a low aspect ratio;
a formation defined by one or more of the sidewalls for orientating the leads to extend from the interior to an exterior of the package, wherein the package has one or more of the following transmission rates:
less than 1×10⁻¹² cm3.cm/cm2/s/Pa for water vapor;
less than 1×10⁻¹³ cm3.cm/cm2/s/Pa for oxygen gas; and
less than 1×10⁻⁹ cm3.cm/cm2/s for the electrolyte.

39. A package for an energy storage device having an energy storage element and at least two leads for allowing electrical connection to the element, the package including:
a plurality of sidewalls for defining an interior to contain the energy storage element and a liquid electrolyte, wherein at least one of the sidewalls is formed from liquid crystal polymer (LCP);
a mounting formation defined by one or more of the sidewalls for locating the leads to extend from the interior to an exterior of the package, wherein the package has at least one of the following transmission rates:
less than 1×10⁻⁹ cm3.cm/cm2/s/Pa for water vapor;
less than 1×10⁻⁹ cm3.cm/cm2/s/Pa for oxygen gas; and
less than 1×10-9 cm3.cm/cm2/s for the electrolyte.

40. A package for an energy storage device having an energy storage element and at least two leads for allowing electrical connection to the element, the package including:
a plurality of sidewalls for defining an interior to contain the energy storage element and a liquid electrolyte;
a formation defined by one or more of the sidewalls for locating the leads to extend from the interior to an exterior of the package, wherein the package is substantially rigid and has at least one of the following transmission rates:
less than 1×10⁻⁹ cm3.cm/cm2/s/Pa for water vapor;
less than 1×10⁻⁹ cm3.cm/cm2/s/Pa for oxygen gas; and
less than 1×10-9 cm3.cm/cm2/s for the electrolyte.

41. A device according to claim 40 wherein at least some of the sidewalls form an open-ended hollow central portion and a pair of end portion sidewalls sealingly bonded to the central portion substantially covering the open ends.

42. A method for manufacturing a package for an energy storage device having an energy storage element and at least two leads for allowing electrical connection to the element, the method including:
defining, from a plurality of sidewalls, an interior to contain the energy storage element, wherein at least one of the sidewalls is formed from liquid crystal polymer (LCP);
providing a mounting formation defined by one or more of the sidewalls for locating the leads to extend from the interior to an exterior of the package, wherein the package has one or more of the following transmission rates:
less than 1×10⁻¹² cm3.cm/cm2/s/Pa for water vapor;
less than 1×10⁻¹³ cm3.cm/cm2/s/Pa for oxygen gas; and
less than 1×10⁻⁹ cm3.cm/cm2/s for a liquid electrolyte.

43. A package for an electrical device having an electrical element, the package including:
a first sidewall and a second sidewall that are bonded to each other to define a sealed interior to contain the element, wherein the sidewalls each contain a liquid crystal polymer; and
a lead assembly being electrically connected to the element to allow external electrical connection to the element.

44. A package according to claim 43 wherein the interior is hermetically sealed.

45. A package according to claim 43 wherein the electrical device includes at least one energy storage device.

46. A package according to claim 45 wherein the energy storage device is a supercapacitor.
